(19) United States
(12) Patent Application Publication
(10) Pub. No.: US 2025/0349043 A1
(43) Pub. Date: Nov. 13, 2025

(54) GENERATING VISUAL DEPICTIONS OF CORRELATIONS BETWEEN IMAGE LAYER MASKS WITH SUGGESTIVE BOUNDARIES

(71) Applicant: Adobe Inc., San Jose, CA (US)

(72) Inventors: Aasma Garg, Bangalore (IN); Peter Green, Veradale, WA (US)

(21) Appl. No.: 18/659,329

(22) Filed: May 9, 2024

(51) Int. Cl. G06T 11/00; G06T 7/12; G06T 7/136; G06T 7/90

(52) U.S. Cl. CPC G06T 11/001; G06T 7/12; G06T 7/136; G06T 7/90; G06T 2200/24; G06T 2207/10024; G06T 2210/12

(57) ABSTRACT

Methods, systems, and non-transitory computer readable storage media are disclosed for generating visualizations of mask correlations for a layer of a digital image. The disclosed system determines one or more bounding boxes corresponding to one or more hidden areas or one or more visible areas of a layer of a digital image according to a raster mask or a vector mask corresponding to the layer. The disclosed system determines display attributes for the one or more bounding boxes in response to determining that the one or more bounding boxes correspond to the one or more hidden areas or the one or more visible areas. The disclosed system generates, for display with the layer within a graphical user interface, one or more boundary highlights representing the one or more bounding boxes with the display attributes.

### BACKGROUND

Many image editing operations involve the use of different layers and masks corresponding to the layers to produce specific effects in digital images. For example, image editing operations that modify individual elements of a digital image typically utilize one or more layers to isolate the effects of the image editing operations to the image content in the corresponding layers. Additionally, many image editing operations leverage masks to further isolate the effects of image editing operations to specific portions of image content even within a single layer. To illustrate, certain image editing operations utilize masks to hide or reveal specific areas of a layer to hide or reveal image content from one or more layers behind the modified layer. Accordingly, understanding how layers and their corresponding masks interact with each other is an important, and often unintuitive, aspect of digital image editing processes. Conventional image editing systems are limited in the types and amounts of layer and mask information they provide to a user in connection with editing digital images.

### SUMMARY

One or more embodiments provide benefits and/or solve one or more of the foregoing or other problems in the art with systems, methods, and non-transitory computer readable storage media for generating and displaying boundary highlights to represent correlations between masks of layers in digital images. In particular, the disclosed systems determine mask inclusivity attributes of a raster mask and/or a vector mask that indicate inclusive/exclusive boundaries in relation to a particular layer of a digital image. The disclosed systems use the inclusivity attributes and boundaries of the layer and the masks to determine one or more bounding boxes corresponding to hidden or visible areas of the layer. Additionally, the disclosed systems determine display attributes (e.g., color values) for the one or more bounding boxes based in connection with the bounding boxes representing hidden or visible areas of the layer. The disclosed systems generate boundary highlights representing the one or more bounding boxes with the corresponding display attributes and provide the boundary highlights for display with the layer in a graphical user interface. The disclosed systems thus provide visualizations of correlations between masks of layers via the generation and display of boundary highlights for more accurate image editing.

### BRIEF DESCRIPTION OF THE DRAWINGS

Various embodiments will be described and explained with additional specificity and detail through the use of the accompanying drawings.

FIG. 1 illustrates an example system environment in which a mask correlation visualization system operates in accordance with one or more implementations.

FIG. 2 illustrates a diagram of an overview of the mask correlation visualization system generating boundary highlights representing mask correlations for a layer of a digital image in accordance with one or more implementations.

FIG. 3 illustrates a diagram of the mask correlation visualization system determining attributes of a layer and one or more masks associated with the layer in accordance with one or more implementations.

FIG. 4 illustrates a diagram of the mask correlation visualization system determining a bounding box and a boundary highlight for mask correlations in accordance with one or more implementations.

FIG. 5 illustrates a diagram of the mask correlation visualization calculating a boundary of a bounding box of a raster mask in accordance with one or more implementations.

FIG. 6 illustrates a diagram of the mask correlation visualization system calculating a boundary of a bounding box of a vector mask in accordance with one or more implementations.

FIG. 7 illustrates a diagram of the mask correlation visualization system determining display attributes for a bounding box in accordance with one or more implementations.

FIG. 8 illustrates a diagram of the mask correlation visualization system determining layer and/or mask boundary highlights for a non-negative layer inclusivity factor in accordance with one or more implementations.

FIG. 9 illustrates a diagram of the mask correlation visualization system determining layer and/or mask boundary highlights for a negative layer inclusivity factor in accordance with one or more implementations.

FIG. 10A illustrates examples of mask combinations with overlapping regions in accordance with one or more implementations.

FIG. 10B illustrates examples of mask combinations with non-overlapping regions in accordance with one or more implementations.

FIG. 10C illustrates examples of mask combinations with partially overlapping regions in accordance with one or more implementations.

FIG. 11 illustrates a graphical user interface including boundary highlights for a raster mask of a layer in accordance with one or more implementations.

FIG. 12 illustrates a graphical user interface including boundary highlights for a vector mask of a layer in accordance with one or more implementations.

FIG. 13 illustrates a graphical user interface including boundary highlights indicating correlations of a raster mask and a vector mask of a layer in accordance with one or more implementations.

FIG. 14 illustrates a graphical user interface including boundary highlights indicating correlations of a raster mask and a vector mask of a layer in accordance with one or more implementations.

FIG. 15 illustrates a graphical user interface including boundary highlights indicating correlations of a raster mask and a vector mask of a layer in accordance with one or more implementations.

FIG. 16 illustrates a graphical user interface including boundary highlights indicating correlations of a raster mask and a vector mask of a layer in accordance with one or more implementations.

FIG. 17 illustrates a graphical user interface including boundary highlights indicating correlations of a raster mask and a vector mask of a layer in accordance with one or more implementations.

FIG. 18 illustrates a diagram of an example of the mask correlation visualization system in accordance with one or more implementations.

FIG. 19 illustrates a flowchart of a series of acts for generating boundary highlights indicating mask correlations for a layer of a digital image in accordance with one or more implementations.

FIG. 20 illustrates a block diagram of an exemplary computing device in accordance with one or more implementations.

### DETAILED DESCRIPTION

One or more embodiments of the present disclosure include a mask correlation visualization system that generates boundary highlights to visualize correlations of masks in connection with a layer of a digital image. In particular, in response to determining that a layer of a digital image has an existing raster mask and/or an existing vector mask, the mask correlation visualization system determines mask inclusivity attributes and mask boundaries of each existing mask. The mask correlation visualization system uses the mask inclusivity attributes of the mask(s) to determine a layer inclusivity factor for the layer and, based on the characteristics of the mask(s) and the layer, the mask correlation visualization system determines bounding boxes for the layer and/or impacted regions of the layer. Furthermore, the mask correlation visualization system determines display attributes corresponding to the bounding boxes based on the attributes of the mask(s) and layer and generates one or more boundary highlights to display with the layer according to the display attributes. Accordingly, by generating boundary highlights according to correlations of mask(s) in connection with a layer, the mask correlation visualization system provides visual representations of correlations of the mask(s) with the layer.

As mentioned, in one or more embodiments, the mask correlation visualization system determines characteristics of masks (if existing) for a layer of a digital image. In particular, the mask correlation visualization system determines mask inclusivity attributes indicating whether an existing raster mask or a vector mask is exclusive or inclusive. Additionally, the mask correlation visualization system determines mask boundaries, including any inclusive boundaries or exclusive boundaries, for each existing mask. Furthermore, the mask correlation visualization system determines a layer inclusivity factor of the layer based on the mask inclusivity attributes and mask boundaries of the raster mask and/or vector mask.

In one or more additional embodiments, the mask correlation visualization system determines bounding boxes corresponding to hidden and/or visible areas of the layer as determined by the mask(s). For instance, the mask correlation visualization system determines whether and how to display bounding boxes indicating the hidden or visible areas of the layer based on the mask inclusivity attributes and boundaries of the masks and the layer. Furthermore, the mask correlation visualization system determines display attributes (e.g., color values) for the bounding boxes based on whether the bounding boxes correspond to hidden or visible areas of the layer according to the mask and layer characteristics. The mask correlation visualization system also generates boundary highlights representing the determined bounding boxes for display with the layer with the respective display attributes.

Conventional systems that provide image generation typically provide a limited amount of information for masks of layers within graphical user interfaces. Specifically, many conventional systems provide tools for viewing and selecting individual masks or layers from a panel or sidebar. For example, these conventional systems typically provide tools to click on thumbnails of layers or masks to view, hide, or otherwise interact with the respective layers or masks. Although such conventional systems provide tools for viewing boundaries of layers or masks, the conventional systems show individual mask boundaries with no relation to the current layer data or to other masked content (e.g., for cases when a single layer has both a raster mask and a vector mask).

Additionally, the conventional systems are unable to accurately show the results of interactions between one or more masks and a layer for various mask modes. In particular, although the conventional systems provide the combined results of all masks and image editing operations within a layer, the conventional systems frequently display irrelevant or confusing information in response to a selection of a given mask. For example, some conventional systems show selected boundaries of a layer and a one or more regions corresponding to a mask with similar or equal display properties in response to a selection of the mask. Thus, the displayed information can result in confusion of how the mask is affecting the layer (e.g., whether the mask is inclusive or exclusive and/or for which regions of the layer), making it difficult for users of the conventional systems to view and understand how multiple masks interact to modify a given layer of a digital image.

The mask correlation visualization system provides a number of advantages in computing systems that provide masking of individual layers of a digital image. For example, the mask correlation visualization system provides visualizations of correlations between masks and their respective layers via customized boundary highlights. In contrast to conventional systems that show individual mask boundaries, the mask correlation visualization system provides boundary highlights that indicate how any number of masks interact to modify a visibility of one or more portions of a layer. By utilizing mask inclusivity attributes of each raster and/or vector mask of a layer to determine affected areas of the layer and generate boundary highlights with display attributes representing such information, the mask correlation visualization system provides users with easily accessible visual information about layers that contain masks.

Furthermore, the mask correlation visualization system utilizes boundary highlights to display information indicating mask modes within a graphical user interface. In particular, in contrast to conventional systems that merely provide boundaries of visible portions of a layer, the mask correlation visualization system determines unique display attributes for visible and hidden portions of a layer based on corresponding mask modes of the masks affecting the layer. More specifically, the mask correlation visualization system provides visually distinct boundary highlights that provide indications of whether one or more masks for a layer exist (or are otherwise valid) in addition to providing information about the inclusivity or exclusivity of the mask(s) of the layer. The mask correlation visualization system thus leverages attributes of a layer and one or more masks to determine how to present visible boundary highlights overlaid on top of the image content within an image editing interface.

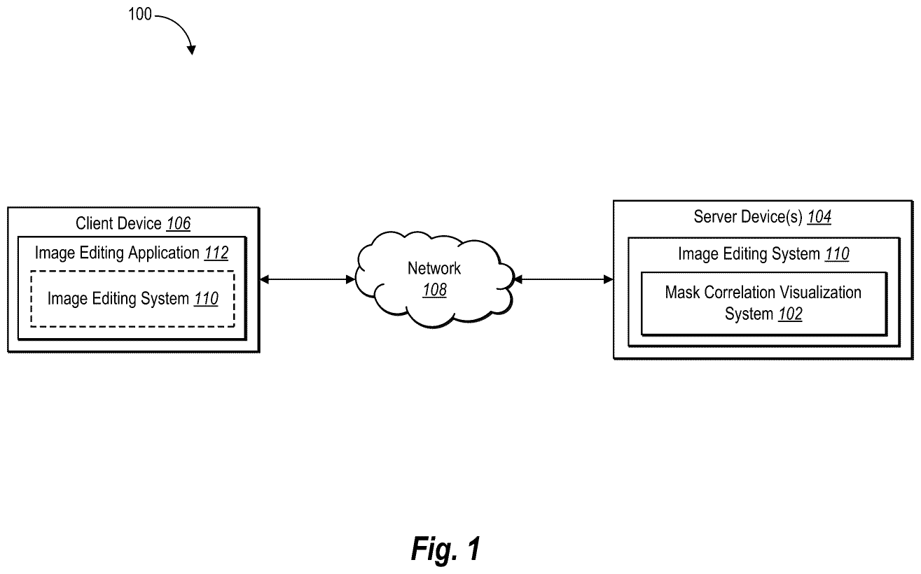

Turning now to the figures, FIG. 1 includes an embodiment of a system environment 100 in which a mask correlation visualization system 102 is implemented. In particular, the system environment 100 includes server device(s) 104 and a client device 106 in communication via a network 108. Moreover, as shown, the server device(s) 104 include an image editing system 110, which includes the mask correlation visualization system 102. Furthermore, the client device 106 includes an image editing application 112, which optionally includes the image editing system 110 (and the mask correlation visualization system 102).

As shown in FIG. 1, the client device 106 or the server device(s) 104 include or host the image editing system 110. The image editing system 110 includes, or is part of, one or more systems that implement digital image generation or editing operations. For example, the image editing system 110 provides tools for generating or editing digital images involving the use of various layers and masks. To illustrate, the image editing system 110 communicates with the client device 106 via the network 108 to provide the tools for display and interaction via the image editing application 112 at the client device 106. Additionally, in some embodiments, the image editing system 110 receives requests to access digital image data stored (e.g., at the server device(s) 104 or at another device such as a database) and/or requests to store digital image data. In some embodiments, the image editing system 110 receives interaction data for viewing or performing various image processing operations and provides the results of the interaction data (e.g., generated digital image data) for display via the image editing application 112 or to a third-party system.

According to one or more embodiments, the image editing system 110 utilizes the mask correlation visualization system 102 to generate visualizations of mask correlations and interactions with layers in digital images. In particular, the mask correlation visualization system 102 extracts inclusivity attributes and boundary attributes of each existing mask and attributes of layers to generate boundary highlights representing affected areas of the layers and how the masks interact to modify the areas of the layers. Accordingly, the mask correlation visualization system 102 utilizes characteristics of layers and their respective raster masks and/or vector masks to generate visualizations of the interactions and correlations of the masks with the layer overlaid on top of digital images in graphical user interfaces.

As illustrated in FIG. 1, the mask correlation visualization system 102 is implemented on the client device 106 or on the server device(s) 104. In particular, in some implementations, the mask correlation visualization system 102 on the server device(s) 104 supports the mask correlation visualization system 102 on the client device 106. For instance, the server device(s) 104 generates or obtains the mask correlation visualization system 102 for the client device 106 (e.g., as part of a software application or suite). The server device(s) 104 provides the mask correlation visualization system 102 to the client device 106 for performing digital image generation/editing processes at the client device 106. In other words, the client device 106 obtains (e.g., downloads) the mask correlation visualization system 102 from the server device(s) 104. At this point, the client device 106 is able to utilize the mask correlation visualization system 102 to generate/edit digital images independently from the server device(s) 104.

In additional embodiments, although FIG. 1 illustrates the server device(s) 104 and the client device 106 communicating via the network 108, the various components of the system environment 100 communicate and/or interact via other methods (e.g., the server device(s) 104 and the client device 106 communicate directly). Furthermore, although FIG. 1 illustrates the mask correlation visualization system 102 being implemented by a particular component and/or device within the system environment 100, the mask correlation visualization system 102 is implemented, in whole or in part, by other computing devices and/or components in the system environment 100. For example, in some embodiments, the server device(s) 104 include or host the image editing system 110 and/or the mask correlation visualization system 102.

To illustrate, the mask correlation visualization system 102 includes a web hosting application that allows the client device 106 to interact with content and services hosted on the server device(s) 104 (e.g., in a software as a service implementation). To illustrate, in one or more implementations, the client device 106 accesses a web page supported by the server device(s) 104. The client device 106 provides input to the server device(s) 104 to view information for layers and/or masks and, in response, the mask correlation visualization system 102 or the image editing system 110 on the server device(s) 104 performs operations to generate visualizations of mask correlations for the layers/masks. The server device(s) 104 provide the output or results of the operations to the client device 106.

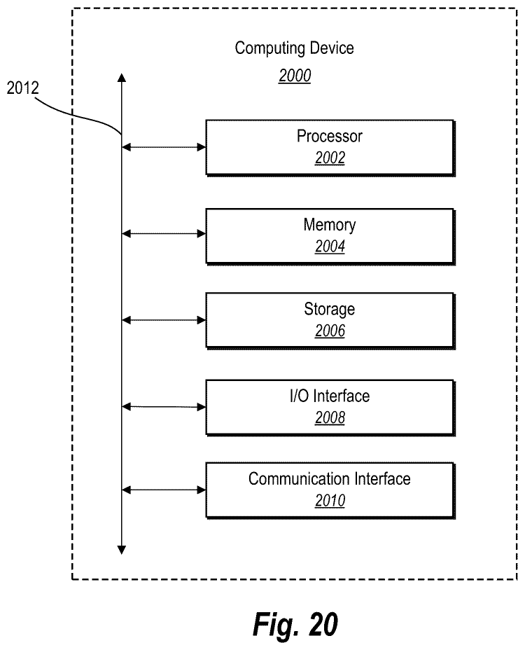

In one or more embodiments, the server device(s) 104 include a variety of computing devices, including those described below with reference to FIG. 20. For example, the server device(s) 104 includes one or more servers for storing and processing data associated with image generation and editing. In some embodiments, the server device(s) 104 also include a plurality of computing devices in communication with each other, such as in a distributed storage environment. In some embodiments, the server device(s) 104 include a content server. The server device(s) 104 also optionally includes an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 20). Furthermore, although not shown in FIG. 1, the client device 106 is operable by a user (e.g., a user included in, or associated with, the system environment 100) to perform a variety of functions. In particular, the client device 106 performs functions such as, but not limited to, accessing, viewing, generating, and editing digital images. In some embodiments, the client device 106 also performs functions for generating, capturing, or accessing data to provide to the image editing system 110 and the mask correlation visualization system 102 in connection with editing digital images. For example, the client device 106 communicates with the server device(s) 104 via the network 108 to provide information (e.g., user interactions) associated with digital images. Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 20.

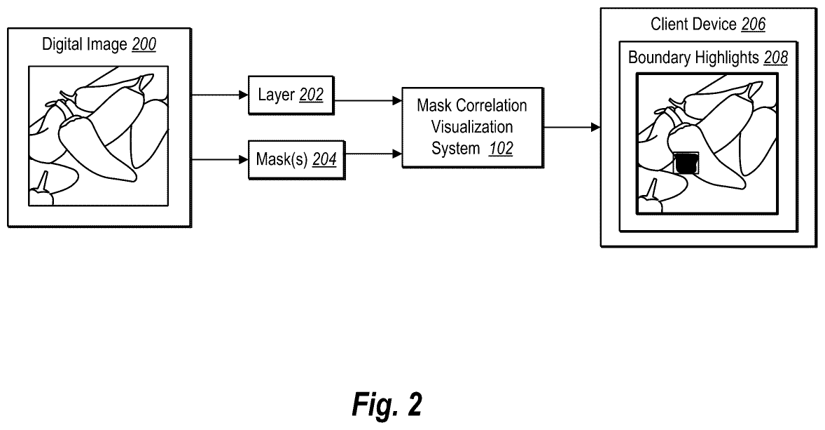

As mentioned, the mask correlation visualization system 102 utilizes inclusivity and boundary information extracted from one or more masks of a layer of a digital image to generate visualizations of correlations between the mask(s) for display with the layer in a graphical user interface. FIG. 2 illustrates an example of the mask correlation visualization system 102 generating boundary highlights to represent mask correlations for a layer of a digital image. In particular, as described in more detail below, the mask correlation visualization system 102 utilizes information extracted from the layer and one or more masks corresponding to the layer to generate visible boundaries with display attributes that indicate the specifics of these correlations.

As illustrated in FIG. 2, the mask correlation visualization system 102 determines a digital image including one or more layers in connection with generating and/or editing the digital image. In one or more embodiments, the digital image 200 includes a raster image for editing within an image editing application. For instance, as mentioned with respect to FIG. 1, the mask correlation visualization system 102 accesses the digital image 200 in connection with generating and/or editing various aspects of the digital image 200 in an image editing application.

Additionally, as illustrated, the mask correlation visualization system 102 determines a layer 202 corresponding to the digital image 200 and mask(s) 204 corresponding to the layer 202. In one or more embodiments, the layer 202 includes a separate set of one or more elements in the digital image 200 that are stored separately from other elements of the digital image 200. For example, the layer 202 includes elements on which various operations are applied independently from other elements in other layers of the digital image. Additionally, in various embodiments, the layer 202 combines with other layers to result in a combined appearance for the digital image 200 (e.g., according to visibility of portions of the layers, layer orders, and/or multi-layer effects.

Additionally, in some embodiments, the mask(s) 204 include a raster mask and/or a vector mask that applies various visibility conditions to one or more portions of the layer 202. Specifically, the mask(s) 204 provide a nondestructive operation for indicating one or more portions of the layer 202 to hide or display in the final digital image without modifying the content of the layer 202 itself. To illustrate, a mask indicates one or more areas of the layer 202 to hide or display based on a selected mode (e.g., inclusive or exclusive) according to a drawing, selection, or other input via a client device. Furthermore, a raster mask includes a mask with raster elements (e.g., pixels) to indicate specific portions of the layer 202 to include or exclude. In one or more embodiments, a vector mask includes a mask with vector elements (e.g., vector paths) to indicate which portions of the layer 202 to include or exclude.

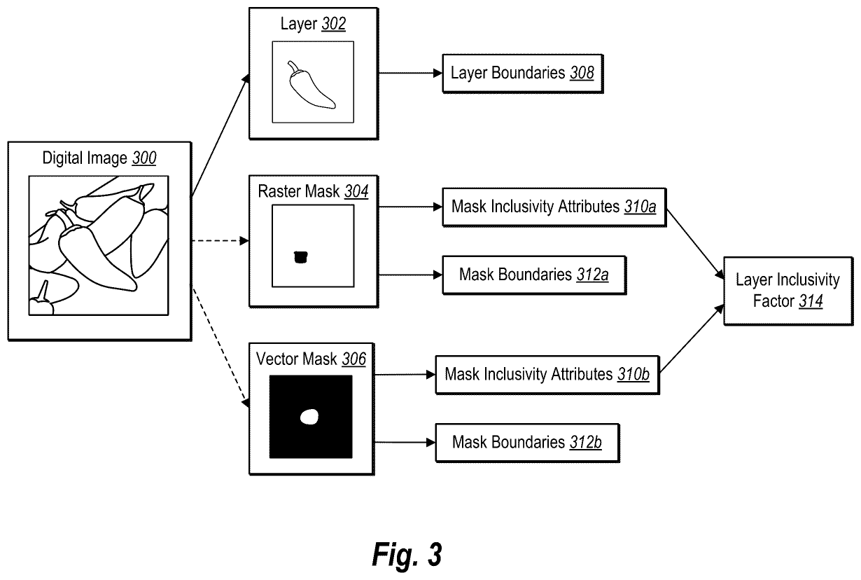

In at least some embodiments, the mask correlation visualization system 102 extracts attributes from the layer 202 and the mask(s) 204 to determine how the mask(s) 204 affect the layer 202. In particular, the mask correlation visualization system 102 determines mask inclusivity attributes indicating whether one or more of the mask(s) 204 are inclusive or exclusive. The mask correlation visualization system 102 also determines inclusive and/or exclusive boundaries of areas of the mask(s) 204. The mask correlation visualization system 102 also determines boundaries of the layer and a layer inclusivity factor indicating inclusive/exclusive attributes of the layer based on the mask inclusivity attributes of the mask(s) 204. FIG. 3 and the corresponding description provide additional details related to determining attributes of a layer and corresponding mask(s) in a digital image.

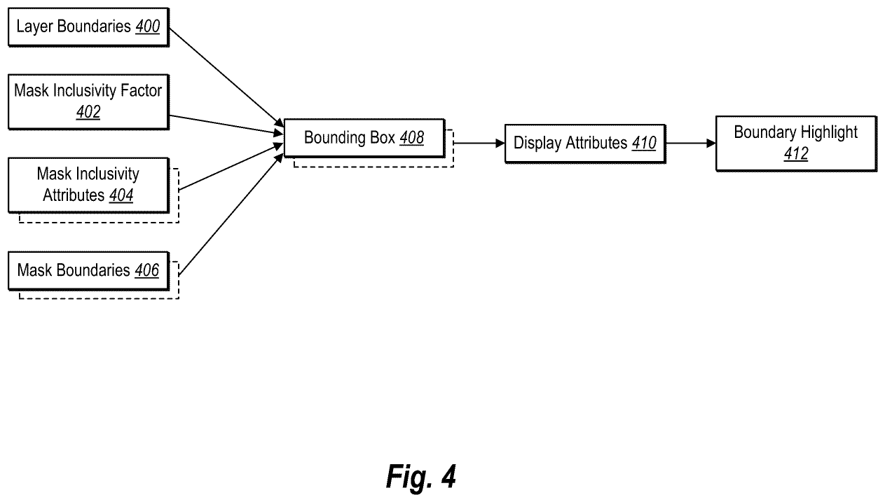

Additionally, as illustrated in FIG. 2, the mask correlation visualization system 102 utilizes the information extracted from the layer 202 and the mask(s) to generate information for display via a graphical user interface of a client device 206. Specifically, the mask correlation visualization system 102 generates boundary highlights 208 to represent the areas of the layer 202 affected by the mask(s) 204 according to extracted information. Furthermore, the mask correlation visualization system 102 also determines display attributes (e.g., color values) for the boundary highlights 208 to present information about the inclusivity/exclusivity of the mask(s) 204 and how such information affects the layer 202. For example, FIG. 4 and the corresponding description provide additional detail related to generating boundary highlights.

As mentioned, in one or more embodiments, the mask correlation visualization system 102 determines attributes of a layer and one or more masks corresponding to the layer. FIG. 3 illustrates an embodiment in which the mask correlation visualization system 102 determines attributes for a layer and attributes for a raster mask and/or a vector mask. FIG. 3 also illustrates that the mask correlation visualization system 102 utilizes the attributes of the raster mask and/or vector mask to determine a layer inclusivity factor for the layer.

In one or more embodiments, the mask correlation visualization system 102 determines a digital image 300 including one or more layers (e.g., layer 302). Additionally, as illustrated in FIG. 3, the mask correlation visualization system 102 determines a raster mask 304 and/or a vector mask 306 associated with the layer 302. In particular, the mask correlation visualization system 102 determines whether each of the raster mask 304 or the vector mask 306 is existing for the layer 302. For example, the mask correlation visualization system 102 determines whether the raster mask 304 exists for the layer 302 and separately determines whether the vector mask 306 exists for the layer 302.

In connection with determining the layer 302 and the raster mask 304 and/or the vector mask 306, the mask correlation visualization system 102 determines specific characteristics of the layer 302 and mask(s). Specifically, the mask correlation visualization system 102 determines layer boundaries 308 for the layer 302. To illustrate, the mask correlation visualization system 102 determines the layer boundaries 308 by accessing metadata stored with the digital image 300. Alternatively, the mask correlation visualization system 102 determines the layer boundaries 308 by communicating with an image editing application with such information. In some embodiments, the mask correlation visualization system 102 determines the layer boundaries 308 by identifying a rectangular bounding box including all non-zero or non-null image content in the layer 302.

Additionally, in one or more embodiments, the mask correlation visualization system 102 determines mask inclusivity attributes of each mask associated with the layer 302. In particular, the mask correlation visualization system 102 determines first mask inclusivity attributes 310a indicating whether the raster mask 304 (if existing) is in an inclusive mode or an exclusive mode. Furthermore, the mask correlation visualization system 102 determines second mask inclusivity attributes 310b indicating whether the vector mask 306 (if existing) is in an inclusive mode or an exclusive mode.

In one or more embodiments, “exclusive” mask inclusivity attributes indicate that the mask controls one or more areas of the layer 302 to hide in response to an input selecting, painting, drawing, etc., the corresponding portions of the mask. Additionally, “inclusive” mask inclusivity attributes indicate that the mask controls one or more areas of the layer 302 to reveal/make visible in response to an input selecting, painting, drawing, etc., the corresponding portions of the mask. In various embodiments, the raster mask 304 and the vector mask 306 have the same or different inclusivity mode.

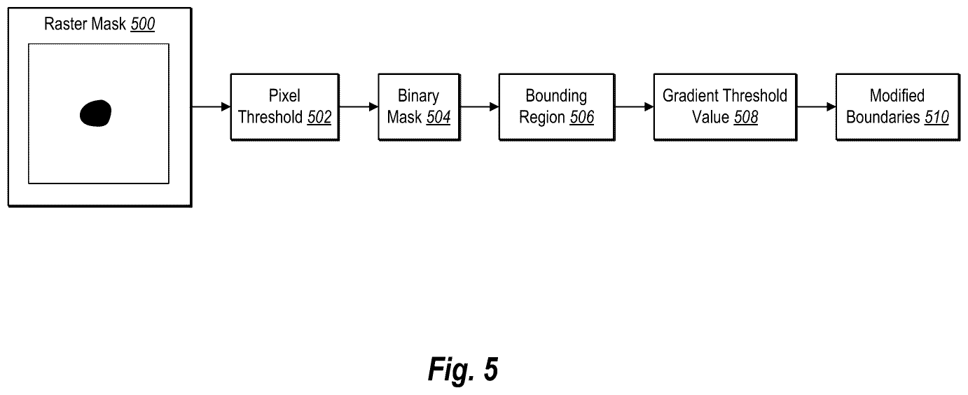

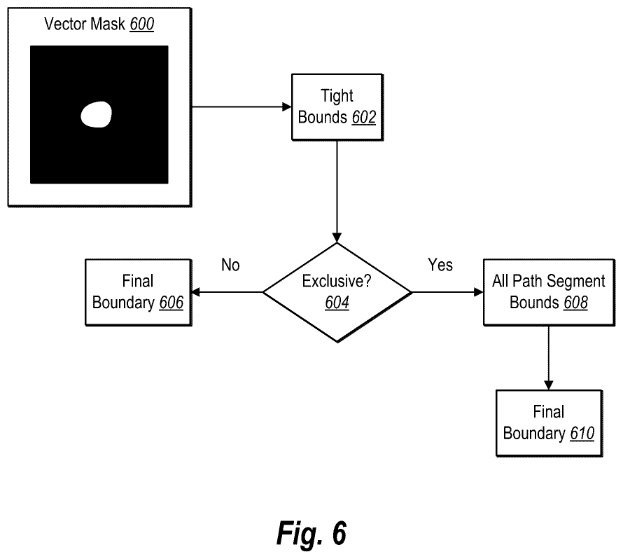

As illustrated in FIG. 3, the mask correlation visualization system 102 also determines mask boundaries for the mask(s). For example, the mask correlation visualization system 102 determines first mask boundaries 312a for the raster mask 304 (if existing) and second mask boundaries 312b for the vector mask 306 (if existing). In one or more embodiments, the mask correlation visualization system 102 determines exclusive boundaries of the raster mask 304 and/or the vector mask 306 indicating portions of the mask(s) corresponding to hidden areas of the layer 302 (e.g., areas replaced with transparency or content from layers below the layer 302 in an image editing interface). Furthermore, the mask correlation visualization system 102 determines inclusive boundaries of the raster mask 304 and/or the vector mask 306 indicating portions of the mask(s) corresponding to the visible areas of the layer 302 (e.g., areas reproduced with their corresponding pixel values in an image editing interface). FIGS. 5-6 and the corresponding descriptions provide additional detail related to determining mask boundaries for raster and vector masks.

FIG. 3 also illustrates that the mask correlation visualization system 102 determines a layer inclusivity factor 314 for the layer 302 itself. In particular, the mask correlation visualization system 102 determines how the mask(s) affect the layer 302 based on the existence of the raster mask 304 and the vector mask 306. Furthermore, the mask correlation visualization system 102 determines the layer inclusivity factor 314 based on the first mask inclusivity attributes 310a and/or the second mask inclusivity attributes 310b. In one or more embodiments, the mask correlation visualization system 102 indicates whether and how to determine a visualization of a layer boundary based on whether the layer boundary corresponds to exclusive content or inclusive content according to the mask(s).

According to one or more embodiments, the mask correlation visualization system 102 determines the layer inclusivity factor 314 based on the values indicated by the mask inclusivity attributes of the mask(s). In one or more embodiments, the mask correlation visualization system 102 assigns mask inclusivity attributes for the masks from a set {0, 1, −1}, where a value of −1 indicates that the mask is not existing, 0 indicates that the mask is exclusive, and 1 indicates that the mask is inclusive. Furthermore, the mask correlation visualization system 102 assigns a value to the layer inclusivity factor 314 from the set {0, 1, −1}, where a value of 0 indicates that the mask is exclusive, 1 indicates that the mask is inclusive, and a value of −1 indicates that the layer boundary may be drawn/visible based on the mask inclusivity attributes of the mask(s). For example, in one or more embodiments, the mask correlation visualization system 102 determines the layer inclusivity factor 314 as:

$${M}_{l} = \{ \begin{matrix}- 1 , & min ( {M}_{r} , {M}_{v} ) \geq 0 \\ ( 1 - max ( {M}_{r} , {M}_{v} ) & else\end{matrix}$$

in which Mₗ represents the layer inclusivity factor 314 and Mᵣ and Mᵥ represent the mask inclusivity attributes of the raster mask 304 and the vector mask 306, respectively. Specifically, the algorithm above applies to situations in which one or more of the raster mask 304 or the vector mask 306 exists (e.g., Mᵣ or Mᵥ is 0 or 1). Although the above example utilizes the set {0, 1, −1}, the mask correlation visualization system 102 utilizes other values to indicate the corresponding mask inclusivity modes in other embodiments.

In at least some embodiments, in response to determining characteristics of a layer and one or more masks applied to the layer, the mask correlation visualization system 102 determines one or more boundary highlights to display with the layer. FIG. 4 illustrates an diagram in which the mask correlation visualization system 102 determines how and where to display one or more boundary highlights based on one or more masks applied to a layer of a digital image.

In one or more embodiments, as illustrated in FIG. 4, the mask correlation visualization system 102 determines layer boundaries 400 and a layer inclusivity factor 402 for a layer. Additionally, in one or more embodiments, the mask correlation visualization system 102 determines mask inclusivity attributes 404 and mask boundaries 406 for a raster mask and/or a vector mask corresponding to the layer. For instance, the mask correlation visualization system 102 determines the characteristics of the layer and the mask(s) as described above with respect to FIG. 3.

The mask correlation visualization system 102 utilizes the characteristics of the layer and/or the characteristics of the mask(s) to determine one or more bounding boxes (e.g., bounding box 408) corresponding to one or more areas of the layer. Specifically, the mask correlation visualization system 102 determines whether and how to draw layer bounds and/or mask bounds based on the specific inclusivity modes and boundaries of the layer and the mask(s). For example, the mask correlation visualization system 102 determines bounding boxes for the layer and/or specific areas of the layer indicated by one or more masks according to a plurality of scenarios related to the layer boundaries 400, the layer inclusivity factor 402, the mask inclusivity attributes 404, and the mask boundaries 406.

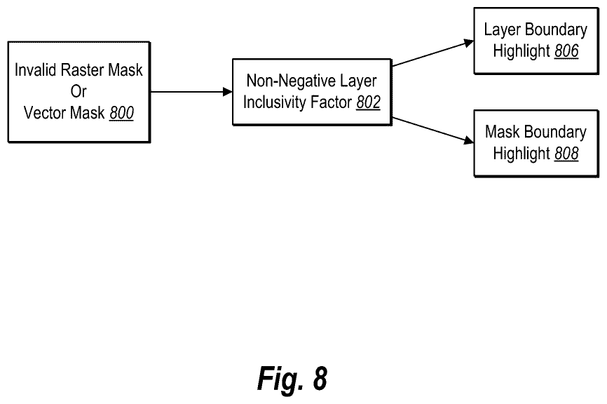

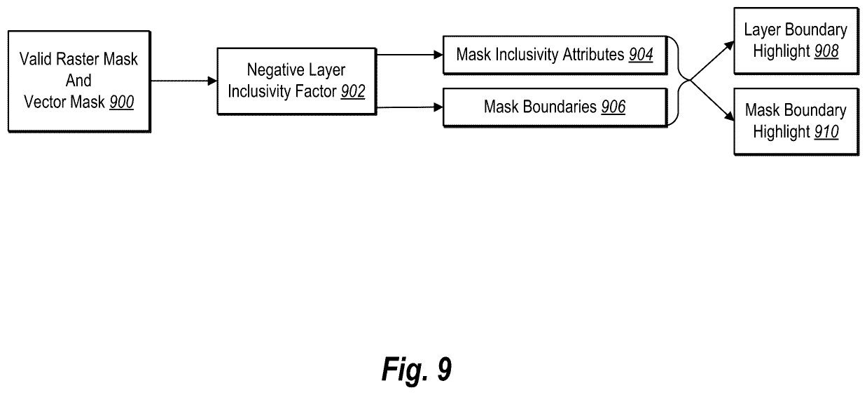

To illustrate, a first scenario corresponds to a non-negative layer inclusivity factor indicating that the layer boundaries are highlighted. More specifically, the first scenario indicates that the raster mask and/or the vector mask exists. Additionally, a second scenario corresponds to a negative layer inclusivity factor according to different combinations of an existing raster mask and an existing vector mask. FIGS. 8-9 and the corresponding descriptions provide additional detail related to determining layer boundary highlights and mask boundary highlights for the different scenarios.

In response to determining the bounding box 408, the mask correlation visualization system 102 determines display attributes 410 for the bounding box 408. In particular, the mask correlation visualization system 102 utilizes information about the layer and/or mask(s) to determine how to visualize the bounding box 408 according to correlations between the one or more masks and the effects of the masks on the layer. To illustrate, the mask correlation visualization system 102 determines a size and location of the bounding box 408 based on the layer boundaries 400 and/or the mask boundaries 406. Furthermore, the mask correlation visualization system 102 determines a color value (e.g., alpha/opacity value, HSV value, RGB value) for the bounding box 408 based on the layer inclusivity factor 402 and/or the mask inclusivity attributes 404.

According to one or more embodiments, the mask correlation visualization system 102 generates a boundary highlight 412 with the display attributes 410 for display with the layer in a graphical user inter interface. For instance, the mask correlation visualization system 102 generates the boundary highlight 412 to display as an overlay on top of a digital image including the layer in and editing interface of an image editing application. In some embodiments, the mask correlation visualization system 102 generates the boundary highlight 412 in response to a selection of the layer and/or one or more masks in a toolbar of the image editing application. In additional embodiments, the mask correlation visualization system 102 provides a plurality of boundary highlights with corresponding display attributes representing different mask/layer information with the layer in a graphical user interface, as described above.

As mentioned, FIG. 5 illustrates an example of the mask correlation visualization system 102 determining boundaries of a raster mask. In particular, the mask correlation visualization system 102 determines a raster mask 500 corresponding to a layer. As mentioned, in some embodiments, the raster mask 500 includes an alpha matte with alpha values. Accordingly, in connection with determining the raster mask 500, the mask correlation visualization system 102 utilizes a pixel threshold 502 to determine a binary mask 504 from the raster mask 500.

More specifically, the mask correlation visualization system 102 thresholds the values in the raster mask 500 to cause the values to be binary (e.g., 0x0 or 0xFF hex values in a 256-value color scale or values). As an example, the mask correlation visualization system 102 selects a color value in the middle of the color range (e.g., 0x80) as the pixel threshold 502. The mask correlation visualization system 102 compares the pixel values in the raster mask 500 to the pixel threshold 502 and thresholds the pixel values toward 0x0 or 0xFF as:

$${R}_{t} [ i , j ] = \{ \begin{matrix}0 \times FF , & R [ i , j ] \geq 0 \times 80 \\ 0 \times 0 & R [ i , j ] < 0 \times 80\end{matrix}$$

where i and j represent pixel coordinates of the pixels in the raster mask 500. Alternatively, the mask correlation visualization system 102 determines a binary mask including values of 0 (e.g., corresponding to 0x0) or 1 (e.g., corresponding to 0xFF).

In response to determining the binary mask 504, the mask correlation visualization system 102 utilizes the binary values in the binary mask 504 to determine a bounding region 506 (e.g., one or more rectangles) corresponding to one or more areas indicated in the raster mask 500. In particular, the mask correlation visualization system 102 utilizes a boundary finding algorithm to identify the bounding region 506 utilizing the thresholded values in the binary mask 504. For example, the mask correlation visualization system 102 determines an inclusive bounding region Rᵢ based on pixel values of 0x0 (e.g., as an input slip to the boundary finding algorithm) in the binary mask 504. Additionally, the mask correlation visualization system 102 determines an exclusive bounding region Rₑ based on pixel values of 0xFF (e.g., as an input slip to the boundary finding algorithm) in the binary mask 504. To illustrate, the mask correlation visualization system 102 determines the bounding region 506 for which pixel values do not match the input slip as:

$${B}_{r} = \{ \begin{matrix}{R}_{i} & if {R}_{i} is contained within {R}_{e} \\ {R}_{e} & else , {R}_{e} is contained within {R}_{i}\end{matrix}$$

In one or more embodiments, the mask correlation visualization system 102 also adjusts the bounding region 506 to adjust for pixel values previously thresholded to determine the binary mask 504. Specifically, the mask correlation visualization system 102 adjusts the bounding region 506 by considering alpha values corresponding to gradients in the raster mask 500. For instance, the mask correlation visualization system 102 adjusts each of the edges of the bounding region 506 according to a gradient threshold value 508.

As an example, the mask correlation visualization system 102 adjusts a bounding region top edge as:

For each i:{top, document top coordinate} and j:{left, right}, run

$$abs ( R [ i , j ] - R [ i - 1 , j ] ) > δ$$

and record the lowest i that satisfies the gradient threshold value δ.

In one or more embodiments, the mask correlation visualization system 102 adjusts a bounding region bottom edge as:

For each i:{bottom, document bottom coordinate} and j:{left, right}, run

$$abs ( R [ i , j ] - R [ i + 1 , j ] ) > δ$$

and record the highest i that satisfies the gradient threshold value δ.

In one or more embodiments, the mask correlation visualization system 102 adjusts a bounding left edge as:

For each i:{top, bottom} and j:{left, document left coordinate}, run

$$abs ( R [ i , j ] - R [ i , j - 1 ] ) > δ$$

and record the lowest j that satisfies the gradient threshold value δ.

In one or more embodiments, the mask correlation visualization system 102 adjusts a bounding right edge as:

For each i:{top, bottom} and j:{right, document right coordinate}, run

$$abs ( R [ i , j ] - R [ i , j + 1 ] ) > δ$$

and record the highest j that satisfies the gradient threshold value δ.

According to one or more embodiments, the mask correlation visualization system 102 selects δ according to a desired tolerance (e.g., a threshold in value changes between pixels in a given direction). For example, the mask correlation visualization system 102 selects δ as 10, though the gradient threshold value 508 includes higher or lower values in other embodiments.

In response to applying the gradient threshold value 508 to each edge of the bounding region 506, the mask correlation visualization system 102 determines modified boundaries 510. In one or more embodiments, the mask correlation visualization system 102 utilizes the modified boundaries 510 to determine the final bounding box for the one or more indicated areas of the raster mask 500. Accordingly, in some embodiments, the mask correlation visualization system 102 determines the bounding box of the raster mask 500 to include one or more areas indicated by the raster mask 500 as areas to be hidden or visible in the corresponding layer according to the mask inclusivity attributes of the raster mask 500.

FIG. 6 illustrates an example process in which the mask correlation visualization system 102 determines a bounding box for a vector mask. In particular, the mask correlation visualization system 102 determines a vector mask 600 that exists for a layer of a digital image. The mask correlation visualization system 102 utilizes an initial boundary finding algorithm that finds tight bounds 602 of the vector mask 600 as an initial boundary for the vector mask 600. For example, the mask correlation visualization system 102 determines the tight bounds 602 by considering path segments via one or more path transform operations to detect any overlapping or isolated regions of one or more vector paths in the vector mask 600. To illustrate, the mask correlation visualization system 102 utilizes path transform operations such as exclude, include, subtract, overlapping, etc., to determine an initial bounding region indicated by one or more vector paths in the vector mask 600.

Furthermore, as illustrated in FIG. 6, the mask correlation visualization system 102 performs a decision operation 604 to determine whether the vector mask 600 is exclusive. Specifically, the mask correlation visualization system 102 accesses mask inclusivity attributes of the vector mask 600 to determine whether the vector mask 600 is inclusive or exclusive. In response to determining that the vector mask 600 is inclusive, the mask correlation visualization system 102 utilizes the tight bounds 602 as a final boundary 606 (e.g., the tight bounds 602 correspond to a visible area of the layer corresponding to the vector mask 600).

In alternative embodiments, in response to determining that the vector mask 600 is exclusive, the mask correlation visualization system 102 determines all path segment bounds 608 from the vector mask 600. For instance, the mask correlation visualization system 102 determines that the vector mask 600 indicates one or more areas of the layer to hide based on the mask inclusivity attributes of the vector mask 600 and determines a boundary for all path segments included in the vector mask 600. Additionally, the mask correlation visualization system 102 utilizes the all path segment bounds 608 as a final boundary 610 for the vector mask 600. Thus, the mask correlation visualization system 102 utilizes the decision operation to determine which boundaries to use for the vector mask 600 in determining bounding boxes for one or more areas indicated by the vector mask 600.

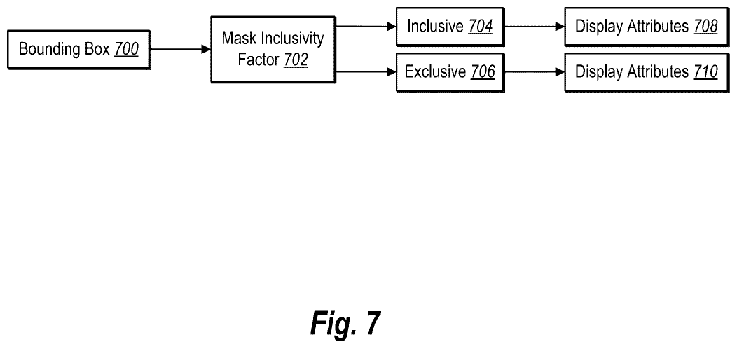

As mentioned, in connection with generating visualizations of mask correlations, the mask correlation visualization system 102 determines display attributes to apply to a boundary highlight for each bounding box displayed with the layer. FIG. 7 illustrates a diagram of a process in which the mask correlation visualization system 102 determines display attributes of one or more bounding boxes. In particular, as illustrated, the mask correlation visualization system 102 determines a bounding box 700 corresponding to a layer, a raster mask, or a vector mask, such as by using the operations described previously to determine bounding boxes for raster masks, vector masks, and layers.

In one or more embodiments, the mask correlation visualization system 102 utilizes the bounding box 700 in connection with a layer inclusivity factor 702 of a layer (or mask inclusivity attributes of a mask) to determine display attributes. For instance, in response to determining that the layer inclusivity factor 702 indicates that the bounding box corresponds to an inclusive 704 mode, the mask correlation visualization system 102 determines first display attributes 708. Alternatively, in response to determining that the layer inclusivity factor 702 indicates that the bounding box corresponds to an exclusive 706 mode, the mask correlation visualization system 102 determines second display attributes 710. More specifically, the first display attributes 708 are visually distinct from the second display attributes 710 to provide a visual indication of the different inclusivity mode of the bounding box 700.

As an example, the mask correlation visualization system 102 determines the display attributes including a color value for the bounding box 700 as:

$$( Boundary color alpha ) x = \{ \begin{matrix}1 - n , & {M}_{x} = 0 ( Exclusive Boundary ) \\ 1 & {M}_{x} = 1 ( Inclusive Boundary )\end{matrix}$$

In which Mₓ corresponds to layer inclusivity factor Mₗ or mask inclusivity attributes Mᵥ, Mᵥ. Furthermore, n represents an integer ranging between {0,1} (excluding extremes). Accordingly, the mask correlation visualization system 102 determines the display attributes 410 to indicate whether a given region of the layer represents visible or hidden content according to the inclusive/exclusive mode of the layer and/or one or more masks. Although the example above indicates determining a color alpha value, in other embodiments, the mask correlation visualization system 102 utilizes other display attributes to indicate specific mask modes or other mask correlation information, such as by modifying HSV/RGB values, modifying line thickness or patterns, or other methods of visually distinguishing types of mask correlations.

In one or more embodiments, the mask correlation visualization system 102 determines drawing patterns for drawing bounding boxes with a layer of a digital image according to the attributes of a raster mask and/or vector mask and the attributes of a corresponding layer. FIGS. 8-9 illustrate examples of the mask correlation visualization system 102 generating boundary highlights based on the possible drawing patterns according to different scenarios, as previously mentioned. Specifically, FIG. 8 illustrates an example of the mask correlation visualization system 102 generating boundary highlights in response to determining that one or more of the raster mask or the vector mask do not exist. FIG. 9 illustrates an example of the mask correlation visualization system 102 generating boundary highlights in response to determining that the raster mask and the vector mask both exist for a layer.

For instance, as illustrated in FIG. 8, the mask correlation visualization system 102 determines, for a layer, that the raster mask or vector mask 800 does not exist in connection with mask inclusivity attributes stored for the respective masks. In connection with determining that the raster mask or the vector mask does not exist (e.g., the mask inclusivity attributes have a stored value of −1 for the respective mask), the mask correlation visualization system 102 determines that the layer has a non-negative layer inclusivity factor 802. To illustrate, the layer inclusivity factor of the layer is either 0 or 1 according to the values previously described.

Accordingly, the mask correlation visualization system 102 determines a layer boundary highlight 806 with display attributes indicating the non-negative layer inclusivity factor 802. For instance, the mask correlation visualization system 102 draws the layer boundary highlight 806 with the chosen color value (e.g., according to a user selection and/or alpha value) corresponding to the non-negative layer inclusivity factor 802. Additionally, the mask correlation visualization system 102 determines a mask boundary highlight 808 to indicate the mask inclusivity attributes of the corresponding existing mask. To illustrate, the mask correlation visualization system 102 generates the mask boundary highlight 808 for an existing raster mask or an existing vector mask with a corresponding color value (e.g., alpha value) to indicate the non-negative mask inclusivity attributes. The mask correlation visualization system 102 does not display a boundary highlight for the non-existing mask.

Additionally, as illustrated in FIG. 9, the mask correlation visualization system 102 determines, for a layer, an existing raster mask and vector mask 900. In particular, the mask correlation visualization system 102 determines that the raster mask and the vector mask are both valid (e.g., existing) for the layer. In some embodiments, the mask correlation visualization system 102 determines that the raster mask and the vector mask exist (e.g., the mask attributes for both masks have a value of either 0 or 1). Additionally, the mask correlation visualization system 102 determines a negative layer inclusivity factor 902 of the layer is −1 as previously indicated.

In response to determining the negative layer inclusivity factor 902, the mask correlation visualization system 102 determines additional conditions based on the attributes of the raster mask and the vector mask. In one or more embodiments, the mask correlation visualization system 102 determines mask inclusivity attributes 904 and mask boundaries 906 of the raster mask and the vector mask 900. In particular, the mask correlation visualization system 102 determines whether each mask is inclusive or exclusive. Additionally, the mask correlation visualization system 102 determines the corresponding inclusive and/or exclusive boundaries of each of the masks.

Furthermore, the mask correlation visualization system 102 determines how and whether to draw a layer boundary highlight 908 for the layer and/or a mask boundary highlight 910 for one or more of the masks based on the mask inclusivity attributes 904 and the mask boundaries 906. For instance, in various combinations of mask inclusivity attributes and mask boundaries of the masks, the mask correlation visualization system 102 determines whether to draw one or more mask boundary highlights and the corresponding display attributes in connection with overlapping regions of interest indicated by the masks, partially overlapping regions of interest indicated by the masks, or non-overlapping regions of interest indicated by the masks. Thus, the mask correlation visualization system 102 determines whether to display the layer boundary highlight 908 and/or the mask boundary highlight 910 (for one or more of the masks) based on the specific combination of the mask inclusivity attributes 904 and the mask boundaries 906.

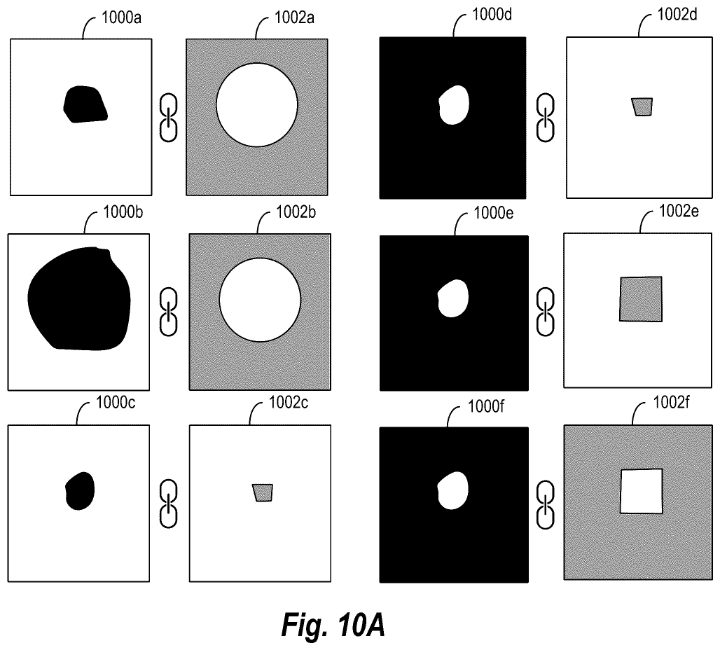

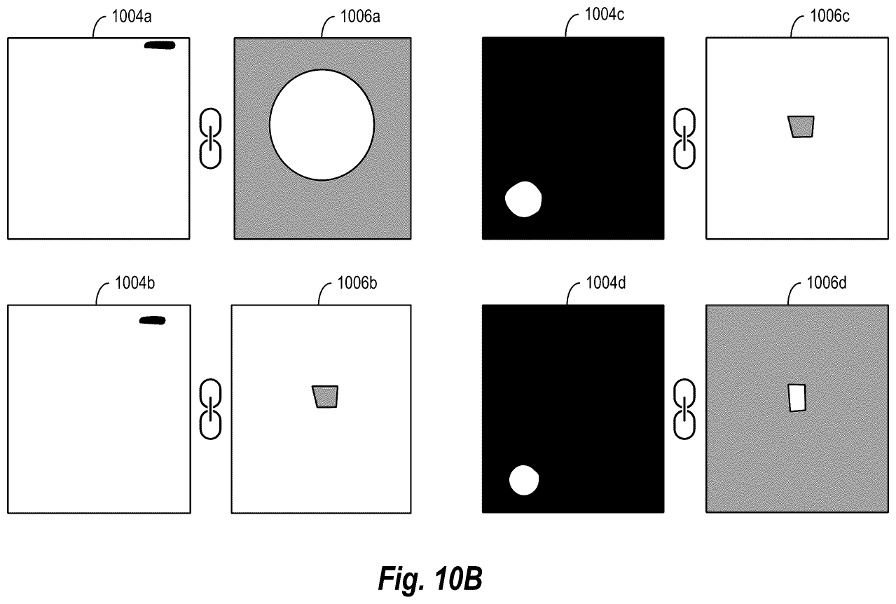

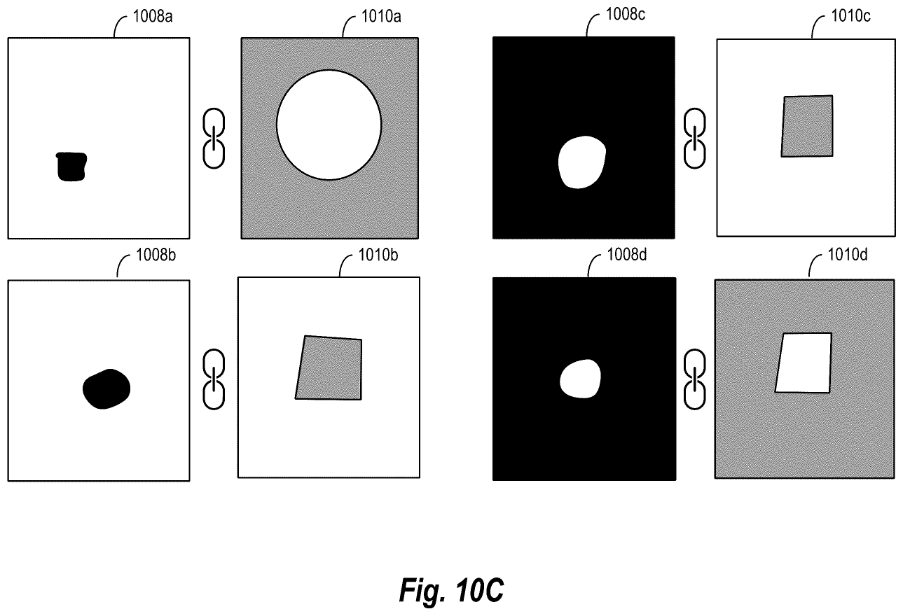

FIGS. 10A-10C illustrate different combinations of raster masks and vector masks according to the possible combinations indicated above with respect to FIG. 9. For example, FIG. 10A illustrates a first combination including a first raster mask 1000a in an exclusive mode and a first vector mask 1002a in an inclusive mode. As illustrated, the first vector mask 1002a has an area with a greater size than and overlaps the entirety of an area of the first raster mask 1000a. Accordingly, the mask correlation visualization system 102 determines to draw boundary highlights for the respective mask areas with color values based on the respective modes of the masks.

FIG. 10A also illustrates a second combination including a second raster mask 1000b in an exclusive mode and a second vector mask 1002b in an inclusive mode. As illustrated, the second raster mask 1000b has an area with a size greater than or equal to (and overlaps with) an area of the second vector mask 1002b. Accordingly, the mask correlation visualization system 102 determines that the final content is hidden and draws no boundaries.

FIG. 10A illustrates a third combination including a third raster mask 1000c in an exclusive mode and a third vector mask 1002c in an exclusive mode. As illustrated, given that both masks are exclusive, the mask correlation visualization system 102 determines a boundary highlight corresponding to a bounding box according to Mask boundary=max (vector mask area|raster mask area). Furthermore, the mask correlation visualization system 102 generates a boundary highlight for the layer with display attributes indicating an inclusive boundary.

FIG. 10A illustrates a fourth combination including a fourth raster mask 1000d in an inclusive mode and a fourth vector mask 1002d in an exclusive mode. As illustrated, the fourth raster mask 1000d has an area with a size greater than or equal to (and overlaps with) an area of the fourth vector mask 1002d. Accordingly, the mask correlation visualization system 102 generates boundary highlights with corresponding color values based on the respective modes of the masks.

FIG. 10A illustrates a fifth combination including a fifth raster mask 1000e in an inclusive mode and a fifth vector mask 1002e in an exclusive mode. As illustrated, the fifth raster mask 1000e has an area with a size less than (and overlaps with) an area of the fifth vector mask 1002e. Accordingly, the mask correlation visualization system 102 determines that the final content is hidden and draws no boundaries.

FIG. 10A illustrates a sixth combination including a sixth raster mask 1000f in an inclusive mode and a sixth vector mask 1002f in an inclusive mode. As illustrated, the mask correlation visualization system 102 determines a boundary highlight corresponding to the masks as Mask boundary=min (vector mask area|raster mask area). Additionally, the mask correlation visualization system 102 determines a boundary highlight for the layer with display attributes indicating an exclusivity boundary.

FIG. 10B illustrates a plurality of combinations of a raster mask and a vector mask for a layer in which the areas indicated by the masks have non-overlapping regions. In particular, FIG. 10B illustrates a first combination including a first raster mask 1004a in an exclusive mode and a first vector mask 1006a in an inclusive mode. As illustrated, the mask correlation visualization system 102 determines a boundary highlight based on a bounding box for the first vector mask 1006a. Additionally, the mask correlation visualization system 102 determines a boundary highlight for the layer with display attributes indicating an exclusivity boundary.

FIG. 10B illustrates a second combination including a second raster mask 1004b in an exclusive mode and a second vector mask 1006b in an exclusive mode. As illustrated, the mask correlation visualization system 102 determines a boundary highlight based on Mask boundary={vector mask area}∪{raster mask area}. Additionally, the mask correlation visualization system 102 determines a boundary highlight for the layer with display attributes indicating an inclusivity boundary.

FIG. 10B illustrates a third combination including a third raster mask 1004c in an inclusive mode and a third vector mask 1006c in an exclusive mode. As illustrated, the mask correlation visualization system 102 determines a boundary highlight based on a bounding box for the third raster mask 1004c. Additionally, the mask correlation visualization system 102 determines a boundary highlight for the layer with display attributes indicating an exclusivity boundary.

FIG. 10B illustrates a fourth combination including a fourth raster mask 1004d in an inclusive mode and a fourth vector mask 1006d in an inclusive mode. As illustrated, the mask correlation visualization system 102 determines that the areas of the masks do not overlap. Accordingly, the mask correlation visualization system 102 determines that the final content is hidden and does not draw any boundaries.

FIG. 10C illustrates a plurality of combinations of a raster mask and a vector mask in which areas indicated by the masks partially overlap. For example, FIG. 10C illustrates a first combination of a first raster mask 1008a in an exclusive mode and a first vector mask 1010a in an inclusive mode. The mask correlation visualization system 102 determines a boundary highlight for the first raster mask 1008a based on a bounding box determined by Bᵣ=Bᵣ.limit (Bᵥ). Furthermore, the mask correlation visualization system 102 determines a boundary highlight for the first vector mask 1010a based on the area indicated by the first vector mask 1010a with a color value indicating inclusivity.

FIG. 10C illustrates a second combination of a second raster mask 1008b in an exclusive mode and a second vector mask 1010b in an exclusive mode. The mask correlation visualization system 102 determines a boundary highlight for the masks as Mask boundary={vector mask area}∪{raster mask area}. The mask correlation visualization system 102 determines a boundary highlight for the layer with display attributes indicating inclusivity.

FIG. 10C illustrates a third combination of a third raster mask 1008c in an inclusive mode and a third vector mask 1010c in an exclusive mode. The mask correlation visualization system 102 determines a boundary highlight for the third raster mask 1008c and the third vector mask 1010c with display attributes indicating their respective inclusivity modes. In some embodiments, the mask correlation visualization system 102 determines not to draw a boundary highlight for the layer.

FIG. 10C illustrates a fourth combination of a fourth raster mask 1008d in an inclusive mode and a fourth vector mask 1010d in an inclusive mode. The mask correlation visualization system 102 determines a boundary highlight for the masks as Bᵣ=Bᵣ.limit(Bᵥ). The mask correlation visualization system 102 also determines a boundary highlight for the layer with a color value indicating exclusivity.

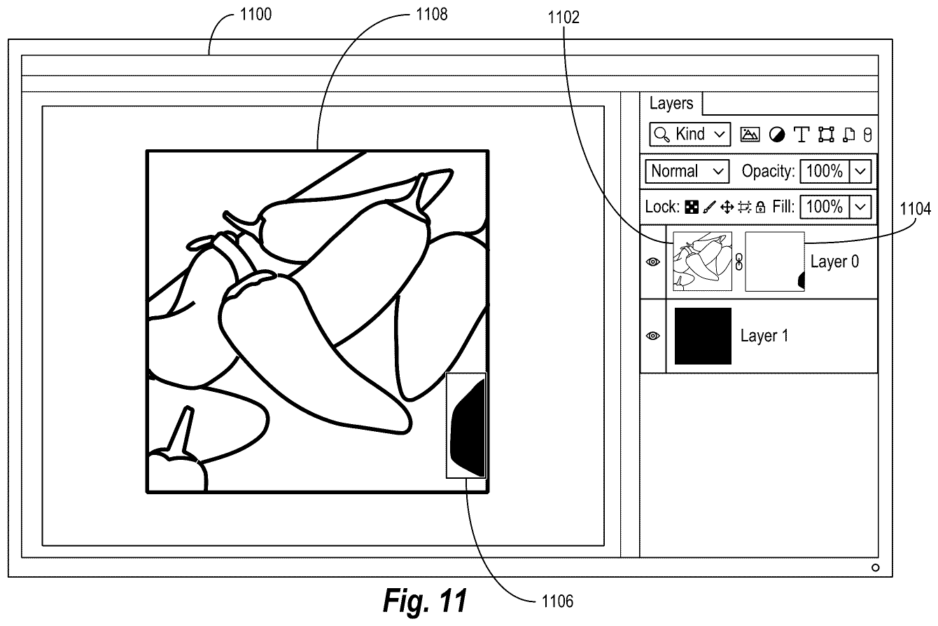

FIGS. 11-17 provide example graphical user interfaces displaying boundary highlights indicating mask correlations for one or more masks in connection with a layer. In particular, FIG. 11 illustrates a client device displaying a graphical user interface 1100 of an image editing application. For example, as illustrated, the client device displays a layer 1102 of a digital image with a mask 1104 (e.g., a raster mask). In connection with determining attributes of the mask and the layer 1102, the mask correlation visualization system 102 generates a first boundary highlight 1106 indicating a hidden area of the layer 1102 and a second boundary highlight 1108 indicating an inclusivity mode of the layer 1102.

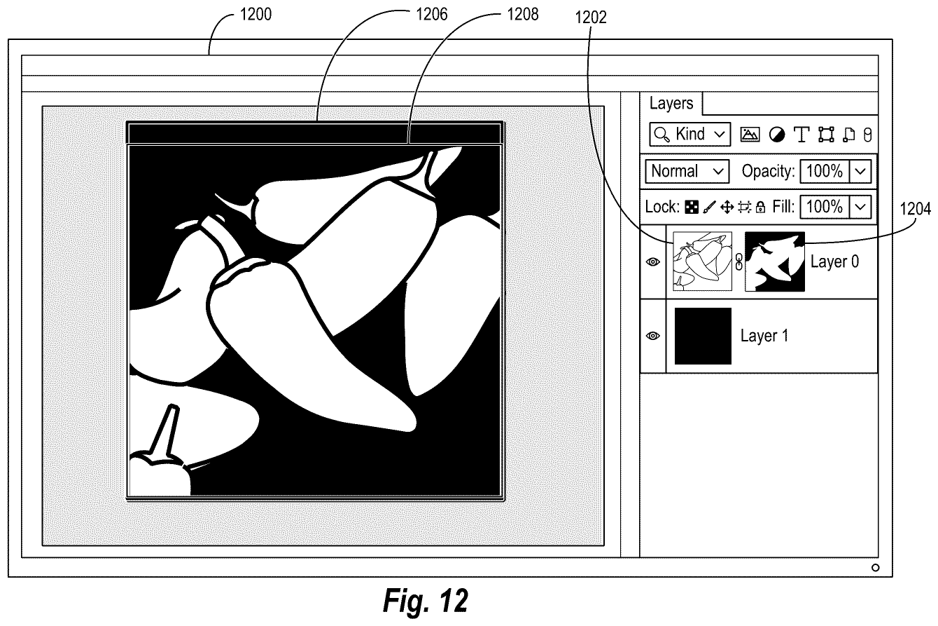

FIG. 12 illustrates a client device displaying a graphical user interface 1200 of an image editing application. As illustrated, the client device displays a layer 1202 of a digital image with a mask 1204 (e.g., a vector mask). In connection with determining attributes of the mask 1204 and the layer 1202, the mask correlation visualization system 102 generates a first boundary highlight 1206 indicating an exclusivity mode of the layer 1202. The mask correlation visualization system 102 also generates a second boundary highlight 1208 indicating visible portions of the layer 1202 indicated by the mask 1204.

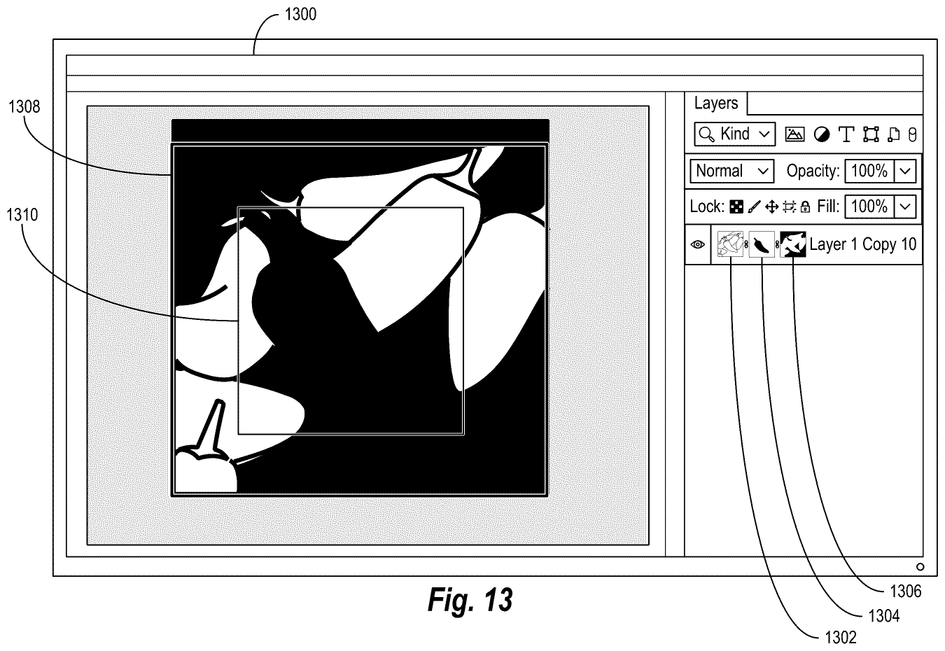

FIG. 13 illustrates a client device displaying a graphical user interface 1300 of an image editing application. As illustrated, the client device displays a layer 1302 of a digital image with a raster mask 1304 and a vector mask 1306. In connection with determining attributes of the raster mask 1304, the vector mask 1306, and the layer 1302, the mask correlation visualization system 102 generates a first boundary highlight 1308 based on the visible areas indicated by the vector mask 1306. The mask correlation visualization system 102 also generates a second boundary highlight 1310 based on the hidden areas indicated by the raster mask 1304 that overlap with the visible areas indicated by the vector mask 1306.

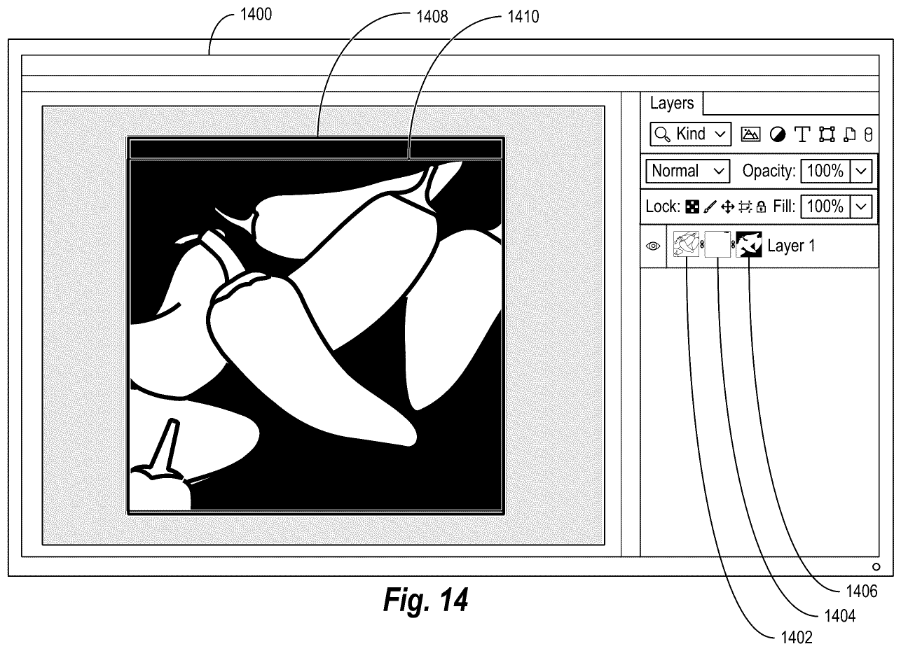

FIG. 14 illustrates a client device displaying a graphical user interface 1400 of an image editing application. As illustrated, the client device displays a layer 1402 of a digital image with a raster mask 1404 and a vector mask 1406. Based on the attributes of the raster mask 1404, the vector mask 1406, and the layer 1402, the mask correlation visualization system 102 generates a first boundary highlight 1408 indicating an exclusivity mode of the layer 1402. The mask correlation visualization system 102 also generates a second boundary highlight 1410 including visible areas of the layer 1402 based on a combination of the raster mask 1404 and the vector mask 1406. Specifically, the raster mask 1404 is in exclusive mode and does not overlap with the vector mask 1406 in inclusive mode, resulting in the vector mask 1406 determining the visible areas of the layer 1402.

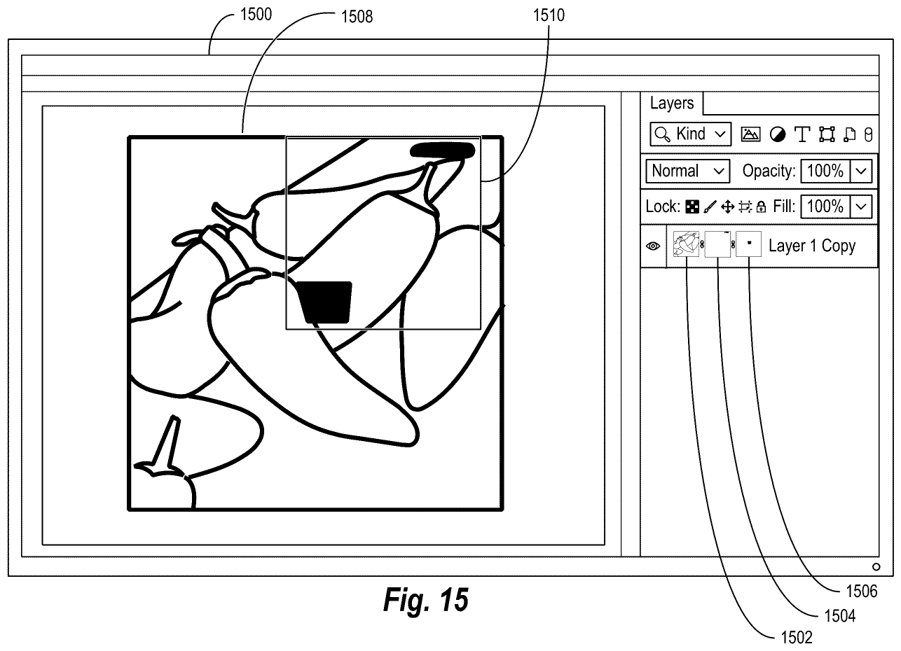

FIG. 15 illustrates a client device displaying a graphical user interface 1500 of an image editing application. As illustrated, the client device displays a layer 1502 of a digital image with a raster mask 1504 and a vector mask 1506. Based on the attributes of the raster mask 1504, the vector mask 1506, and the layer 1502, the mask correlation visualization system 102 generates a first boundary highlight 1508 indicating an inclusivity mode of the layer 1502 given that the masks are both in exclusive mode. The mask correlation visualization system 102 also generates a second boundary highlight 1510 encompassing the hidden areas of the layer 1502 as indicated by the masks.

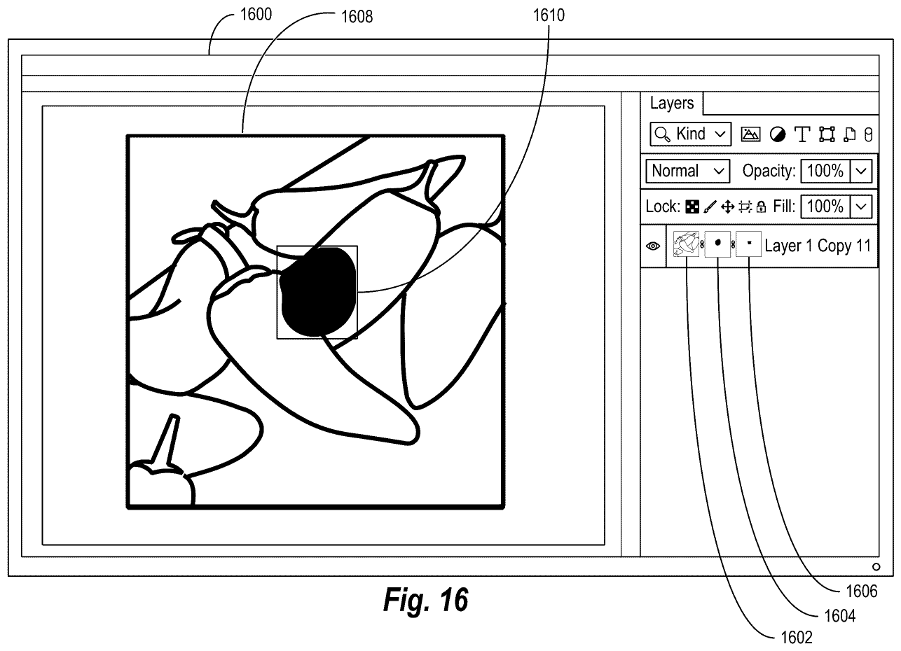

FIG. 16 illustrates a client device displaying a graphical user interface 1600 of an image editing application. As illustrated, the client device displays a layer 1602 of a digital image with a raster mask 1604 and a vector mask 1606. In response to determining that the raster mask 1604 and the vector mask 1606 are in exclusive mode and overlap each other, the mask correlation visualization system 102 generates a first boundary highlight 1608 indicating an inclusivity mode of the layer 1602 given that the masks are both in exclusive mode. Additionally, the mask correlation visualization system 102 generates a second boundary highlight 1610 encompassing the overlapping hidden areas of the layer 1602 as indicated by the masks.

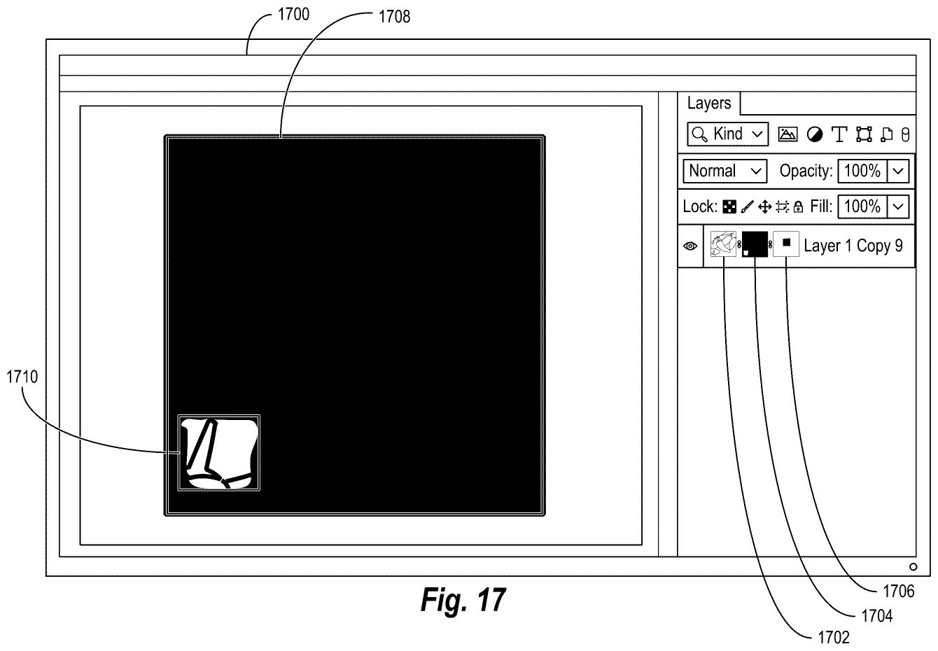

FIG. 17 illustrates a client device displaying a graphical user interface 1700 of an image editing application. As illustrated, the client device displays a layer 1702 of a digital image with a raster mask 1704 and a vector mask 1706. As illustrated, the raster mask 1704 is in inclusive mode and indicates an area of the layer 1702. Additionally, the vector mask 1706 is in exclusive mode and indicates a separate area of the layer 1702 that does not overlap with the area indicated by the raster mask 1704. Accordingly, the mask correlation visualization system 102 generates a first boundary highlight 1708 indicating an exclusivity mode of the layer and a second boundary highlight 1710 including the visible areas of the layer indicated by the raster mask 1704.

Although FIGS. 11-17 indicate specific examples of mask combinations for layers with generated boundary highlights indicating various areas of the layers according to the inclusivity attributes and boundaries of the masks, in other embodiments, the mask correlation visualization system 102 generates different boundary highlights to indicate additional combinations of masks and layer content. For example, the mask correlation visualization system 102 considers layer boundaries for each mask, including determining whether a layer includes transparent values. Furthermore, in some embodiments, the mask correlation visualization system 102 utilizes different display attributes such as color values, line patterns, line thicknesses, line shapes, etc., to indicate different mask or layer inclusivity modes.

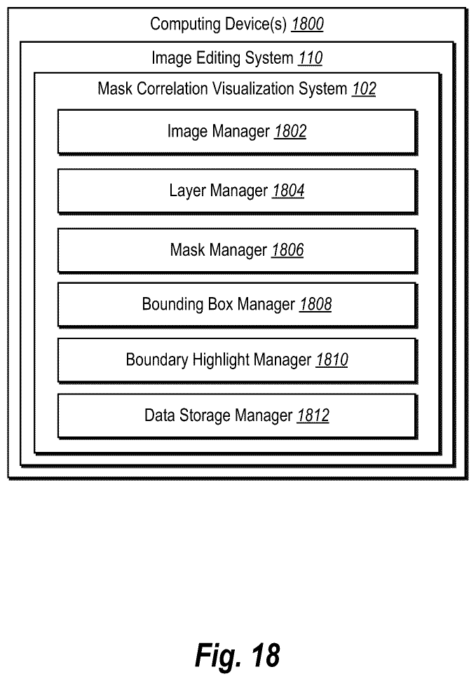

FIG. 18 illustrates a detailed schematic diagram of an embodiment of the mask correlation visualization system 102 described above. As shown, the mask correlation visualization system 102 is implemented in an image editing system 110 on computing device(s) 1800 (e.g., a client device and/or server device as described in FIG. 1, and as further described below in relation to FIG. 20). Additionally, the mask correlation visualization system 102 includes, but is not limited to, an image manager 1802, a layer manager 1804, a mask manager 1806, a bounding box manager 1808, a boundary highlight manager 1810, and a data storage manager 1812. In one or more embodiments, the mask correlation visualization system 102 is implemented on any number of computing devices. For example, the mask correlation visualization system 102, in one or more embodiments, is implemented in a distributed system of server devices for digital image editing. Alternatively, the mask correlation visualization system 102 is also implemented within one or more additional systems. For example, the mask correlation visualization system 102, in one or more embodiments, is implemented on a single computing device such as a single client device.

In one or more embodiments, each of the components of the mask correlation visualization system 102 is in communication with other components using any suitable communication technologies. Additionally, the components of the mask correlation visualization system 102 are capable of being in communication with one or more other devices including other computing devices of a user, server devices (e.g., cloud storage devices), licensing servers, or other devices/systems. It will be recognized that although the components of the mask correlation visualization system 102 are shown to be separate in FIG. 18, any of the subcomponents may be combined into fewer components, such as into a single component, or divided into more components as may serve a particular implementation. Furthermore, although the components of FIG. 18 are described in connection with the mask correlation visualization system 102, at least some of the components for performing operations in conjunction with the mask correlation visualization system 102 described herein may be implemented on other devices within the environment.

In some embodiments, the components of the mask correlation visualization system 102 include software, hardware, or both. For example, the components of the mask correlation visualization system 102 include one or more instructions stored on a computer-readable storage medium and executable by processors of one or more computing devices (e.g., the computing device(s) 1800). When executed by the one or more processors, the computer-executable instructions of the mask correlation visualization system 102 cause the computing device(s) 1800 to perform the operations described herein. Alternatively, the components of the mask correlation visualization system 102 include hardware, such as a special purpose processing device to perform a certain function or group of functions. Additionally, or alternatively, the components of the mask correlation visualization system 102 include a combination of computer-executable instructions and hardware.

Furthermore, the components of the mask correlation visualization system 102 performing the functions described herein with respect to the mask correlation visualization system 102 may, for example, be implemented as part of a stand-alone application, as a module of an application, as a plug-in for applications, as a library function or functions that may be called by other applications, and/or as a cloud-computing model. Thus, the components of the mask correlation visualization system 102 may be implemented as part of a stand-alone application on a personal computing device or a mobile device. Alternatively, or additionally, the components of the mask correlation visualization system 102 may be implemented in any application that provides digital image editing, including, but not limited to ADOBE® PHOTOSHOP® and ADOBE® CREATIVE CLOUD® software.

As illustrated, the mask correlation visualization system 102 includes an image manager 1802 to manage digital images for image editing operations. In particular, the image manager 1802 accesses digital images for editing based on user inputs providing the digital images or accessing the digital images from a database of images. Additionally, the image manager 1802 manages the display of image content within an image editing application in connection with various image editing tools including layer and mask tools.

The mask correlation visualization system 102 includes a layer manager 1804 manages layers of a digital image. In particular, the layer manager 1804 manages layer identifiers, content, ordering, and relationships. Additionally, the layer manager 1804 manages various layer attributes, including layer boundaries and opacity, as well as layer editing operations.

The mask correlation visualization system 102 further includes a mask manager 1806 to manage masks for one or more layers of a digital image. Specifically, the mask manager 1806 manages a raster mask and a vector mask for a layer of a digital image. Additionally, the mask manager 1806 determines mask inclusivity attributes and mask boundaries of a raster mask or a vector mask.

In one or more embodiments, the mask correlation visualization system 102 utilizes a bounding box manager 1808 to generate and manage bounding boxes corresponding to mask correlations for a layer. In particular, the bounding box manager 1808 generates bounding boxes indicating regions of a layer affected by one or more masks. For example, the mask correlation visualization system 102 also determines initial mask boundaries indicated by masks in addition to modifications to the boundaries to account for gradient/alpha values in the masks.

Additionally, the mask correlation visualization system 102 includes a boundary highlight manager 1810 to manage boundary highlights representing visible or hidden areas of a layer based on one or more masks. Specifically, the boundary highlight manager 1810 determines whether to display a particular boundary highlight for a hidden or visible region based on attributes of a layer and one or more masks. The boundary highlight manager 1810 also determines display attributes for bounding boxes represented by the boundary highlights based on the respective mask attributes.

The mask correlation visualization system 102 also includes a data storage manager 1812 (that comprises a non-transitory computer memory) that stores and maintains data associated with editing digital images and generating visualizations of mask correlations. For example, the data storage manager 1812 stores data associated with layers, raster masks, and vector masks. The data storage manager 1812 also stores data associated with determining bounding boxes for hidden/visible areas of layers based on corresponding masks. The data storage manager 1812 also stores information for boundary highlights for displaying in a graphical user interface.

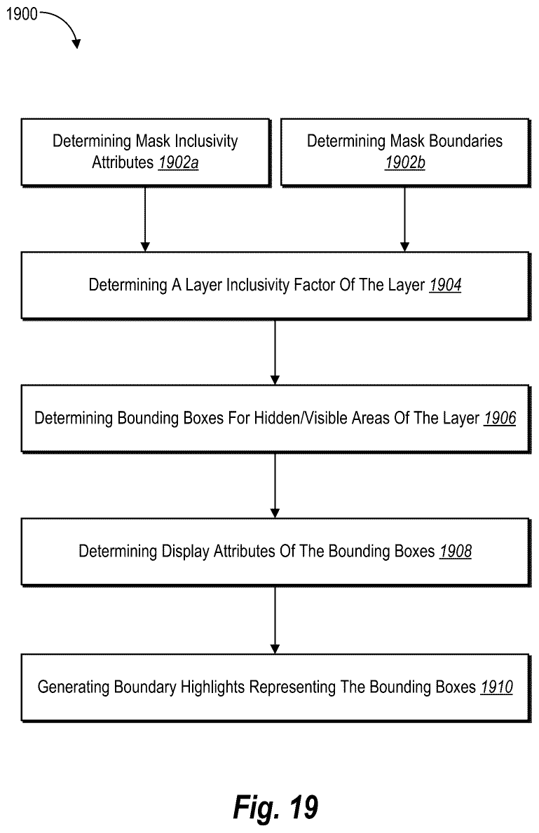

Turning now to FIG. 19, this figure shows a flowchart of a series of acts 1900 of generating boundary highlights indicating mask correlations for a layer of a digital image. While FIG. 19 illustrates acts according to one embodiment, alternative embodiments may omit, add to, reorder, and/or modify any of the acts shown in FIG. 19. The acts of FIG. 19 are part of a method. Alternatively, a non-transitory computer readable medium comprises instructions, that when executed by one or more processors, cause the one or more processors to perform the acts of FIG. 19. In still further embodiments, a system includes a processor or server configured to perform the acts of FIG. 19.

As shown, the series of acts 1900 includes an act 1902a of determining mask inclusivity attributes and an act 1902b of determining mask boundaries for masks of a layer. The series of acts 1900 also includes an act 1904 of determining a layer inclusivity factor of the layer. The series of acts 1900 also includes an act 1906 of determining bounding boxes for hidden/visible areas of the layer. Additionally, the series of acts 1900 includes an act 1908 of determining display attributes of the bounding boxes. The series of acts 1900 further includes an act 1910 of generating boundary highlights representing the bounding boxes.

In one or more embodiments, act 1902a and act 1902b involve determining mask inclusivity attributes and mask boundaries for a raster mask or a vector mask for a layer of a digital image. Additionally, act 1904 involves determining a layer inclusivity factor of the layer based on the mask inclusivity attributes of the raster mask or the vector mask. Act 1906 involves determining one or more bounding boxes corresponding to one or more hidden areas or one or more visible areas of a layer of a digital image according to a raster mask or a vector mask corresponding to the layer. Act 1908 involves determining display attributes for the one or more bounding boxes in response to determining that the one or more bounding boxes correspond to the one or more hidden areas or the one or more visible areas. Furthermore, act 1910 involves generating, for display with the layer within a graphical user interface, one or more boundary highlights representing the one or more bounding boxes with the display attributes.

In one or more embodiments, act 1906 involves determining one or more bounding boxes corresponding to one or more hidden areas of the layer or one or more visible areas of the layer according to the mask boundaries of the raster mask or the vector mask, the layer inclusivity factor of the layer, and layer boundaries of the layer. In one or more embodiments, act 1910 involves generating, for display with the layer within a graphical user interface, one or more boundary highlights representing the one or more bounding boxes corresponding to the one or more hidden areas of the layer or the one or more visible areas of the layer.

In one or more embodiments, the series of acts 1900 includes determining mask inclusivity attributes indicating an inclusive mode or an exclusive mode for the raster mask or the vector mask. The series of acts 1900 also includes determining mask boundaries for one or more regions of the layer indicated by the raster mask or the vector mask.

In some embodiments, the series of acts 1900 includes determining first mask inclusivity attributes and first mask boundaries for the raster mask, and determining second mask inclusivity attributes and second mask boundaries for the vector mask. Additionally, the series of acts 1900 includes determining the one or more bounding boxes corresponding to the one or more hidden areas or the one or more visible areas of the layer based on the first mask inclusivity attributes, the first mask boundaries, the second mask inclusivity attributes, and the second mask boundaries.

In one or more embodiments, the series of acts 1900 includes determining the display attributes for the one or more bounding boxes by determining one or more color values of the one or more bounding boxes based on whether the one or more bounding boxes correspond to the one or more hidden areas or the one or more visible areas of the layer.

In some embodiments, the series of acts 1900 includes determining a layer inclusivity factor of the layer based on mask inclusivity attributes of the raster mask or the vector mask. The series of acts 1900 also includes determining a first bounding box corresponding to a visible area of the layer based on the layer inclusivity factor of the layer and the mask inclusivity attributes of the raster mask or the vector mask. The series of acts 1900 further includes determining a second bounding box corresponding to a hidden area of the layer based on the layer inclusivity factor of the layer and the mask inclusivity attributes of the raster mask or the vector mask.

In one or more embodiments, the series of acts 1900 includes generating, for display with the layer within the graphical user interface, a first boundary highlight representing the first bounding box with a first size and a first color value corresponding to the visible area of the layer. The series of acts 1900 also includes generating, for display with the layer within the graphical user interface, a second boundary highlight representing the second bounding box with a second size and a second color value corresponding to the hidden area of the layer.

In additional embodiments, the series of acts 1900 includes determining an exclusive boundary and an inclusive boundary of the raster mask. The series of acts 1900 further includes thresholding pixel values in the raster mask to convert the raster mask to a binary mask, and determining, from the binary mask, one or more bounding regions based on the exclusive boundary and the inclusive boundary. The series of acts 1900 also includes modifying a bounding region of the one or more bounding regions by adjusting one or more edges of the bounding region to cover one or more gradient values from the raster mask according to a gradient threshold value.

In one or more embodiments, the series of acts 1900 includes determining an initial boundary of the vector mask utilizing one or more path transform operations on one or more path segments of the vector mask. The series of acts 1900 also includes determining the one or more bounding boxes utilizing all path segment boundaries in the vector mask in response to the mask inclusivity attributes of the vector mask indicating that the vector mask is exclusive.

In some embodiments, the series of acts 1900 includes determining first mask inclusivity attributes and first mask boundaries for the raster mask corresponding to the layer, the first mask inclusivity attributes indicating that the raster mask is inclusive or exclusive. The series of acts 1900 also includes determining second mask inclusivity attributes and second mask boundaries for the vector mask corresponding to the layer, the second mask inclusivity attributes indicating that the vector mask is inclusive or exclusive. In one or more embodiments, the series of acts 1900 includes determining the layer inclusivity factor of the layer as exclusive or inclusive based on a combination of the first mask inclusivity attributes of the raster mask and the second mask inclusivity attributes of the vector mask.

In some embodiments, the series of acts 1900 includes determining the one or more bounding boxes further based on the mask inclusivity attributes of the raster mask or the vector mask in connection with the mask boundaries of the raster mask or the vector mask.

In one or more embodiments, the series of acts 1900 includes determining a first bounding box corresponding to a visible area of the layer based on the mask boundaries for the raster mask or the vector mask, the layer inclusivity factor of the layer, and the layer boundaries of the layer. The series of acts 1900 further includes determining a second bounding box corresponding to a hidden area of the layer based on the mask boundaries for the raster mask or the vector mask, the layer inclusivity factor of the layer, and the layer boundaries of the layer.

In one or more embodiments, the series of acts 1900 includes generating a first boundary highlight corresponding to the first bounding box and having a first set of display attributes in response to the first bounding box corresponding to the visible area of the layer. The series of acts 1900 further includes determining a second boundary highlight corresponding to the second bounding box and having a second set of display attributes in response to the second bounding box corresponding to the hidden area of the layer. Additionally, the series of acts 1900 includes determining the first set of display attributes comprises determining a first color value indicating that the first boundary highlight corresponds to the visible area. The series of acts 1900 also includes determining the second set of display attributes comprises determining a second color value indicating that the first boundary highlight corresponds to the hidden area.

In additional embodiments, the series of acts 1900 includes determining, for the raster mask and the vector mask, a single bounding box corresponding to the one or more hidden areas of the layer or the one or more visible areas of the layer based on the mask inclusivity attributes and in response to determining whether the raster mask and the vector mask overlap according to the mask boundaries.

In some embodiments, the series of acts 1900 includes determining mask inclusivity attributes and mask boundaries of the raster mask or the vector mask. The series of acts 1900 also includes determining a bounding box corresponding to a visible area of the layer of the digital image based on the mask inclusivity attributes and the mask boundaries of the raster mask.

In one or more embodiments, the series of acts 1900 includes determining mask inclusivity attributes and mask boundaries of the raster mask or the vector mask. The series of acts 1900 also includes determining a bounding box corresponding to a hidden area of the layer of the digital image based on the mask inclusivity attributes and the mask boundaries of the raster mask.

In one or more embodiments, the series of acts 1900 includes determining a set of display attributes for a bounding box of the one or more bounding boxes in response to determining whether the bounding box corresponds to a hidden area or a visible area of the layer. The series of acts 1900 further includes generating, for display on the digital image with the layer within the graphical user interface, a boundary highlight representing the bounding box with the set of display attributes.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 20 illustrates a block diagram of exemplary computing device 2000 that may be configured to perform one or more of the processes described above. One will appreciate that one or more computing devices such as the computing device 2000 may implement the system(s) of FIG. 1. As shown by FIG. 20, the computing device 2000 can comprise a processor 2002, a memory 2004, a storage device 2006, an I/O interface 2008, and a communication interface 2010, which may be communicatively coupled by way of a communication infrastructure 2012. In certain embodiments, the computing device 2000 can include fewer or more components than those shown in FIG. 20. Components of the computing device 2000 shown in FIG. 20 will now be described in additional detail.

In one or more embodiments, the processor 2002 includes hardware for executing instructions, such as those making up a computer program. As an example, and not by way of limitation, to execute instructions for dynamically modifying workflows, the processor 2002 may retrieve (or fetch) the instructions from an internal register, an internal cache, the memory 2004, or the storage device 2006 and decode and execute them. The memory 2004 may be a volatile or non-volatile memory used for storing data, metadata, and programs for execution by the processor(s). The storage device 2006 includes storage, such as a hard disk, flash disk drive, or other digital storage device, for storing data or instructions for performing the methods described herein.

The I/O interface 2008 allows a user to provide input to, receive output from, and otherwise transfer data to and receive data from computing device 2000. The I/O interface 2008 may include a mouse, a keypad or a keyboard, a touch screen, a camera, an optical scanner, network interface, modem, other known I/O devices or a combination of such I/O interfaces. The I/O interface 2008 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 2008 is configured to provide graphical data to a display for presentation to a user. The graphical data may be representative of one or more graphical user interfaces and/or any other graphical content as may serve a particular implementation.

The communication interface 2010 can include hardware, software, or both. In any event, the communication interface 2010 can provide one or more interfaces for communication (such as, for example, packet-based communication) between the computing device 2000 and one or more other computing devices or networks. As an example, and not by way of limitation, the communication interface 2010 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 2010 may facilitate communications with various types of wired or wireless networks. The communication interface 2010 may also facilitate communications using various communication protocols. The communication infrastructure 2012 may also include hardware, software, or both that couples components of the computing device 2000 to each other. For example, the communication interface 2010 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
determining, by at least one processor, one or more bounding boxes corresponding to one or more hidden areas or one or more visible areas of a layer of a digital image according to a raster mask or a vector mask corresponding to the layer;
determining, by the at least one processor, display attributes for the one or more bounding boxes in response to determining that the one or more bounding boxes correspond to the one or more hidden areas or the one or more visible areas; and
generating, for display with the layer within a graphical user interface, one or more boundary highlights representing the one or more bounding boxes with the display attributes.

2. The computer-implemented method of claim 1, wherein determining the one or more bounding boxes comprises:
determining mask inclusivity attributes indicating an inclusive mode or an exclusive mode for the raster mask or the vector mask; and
determining mask boundaries for one or more regions of the layer indicated by the raster mask or the vector mask.

3. The computer-implemented method of claim 1, wherein determining the one or more bounding boxes comprises:
determining first mask inclusivity attributes and first mask boundaries for the raster mask;
determining second mask inclusivity attributes and second mask boundaries for the vector mask; and
determining the one or more bounding boxes corresponding to the one or more hidden areas or the one or more visible areas of the layer based on the first mask inclusivity attributes, the first mask boundaries, the second mask inclusivity attributes, and the second mask boundaries.

4. The computer-implemented method of claim 1, wherein determining the display attributes for the one or more bounding boxes comprises determining one or more color values of the one or more bounding boxes based on whether the one or more bounding boxes correspond to the one or more hidden areas or the one or more visible areas of the layer.

5. The computer-implemented method of claim 1, wherein determining the one or more bounding boxes comprises:
determining a layer inclusivity factor of the layer based on mask inclusivity attributes of the raster mask or the vector mask;
determining a first bounding box corresponding to a visible area of the layer based on the layer inclusivity factor of the layer and the mask inclusivity attributes of the raster mask or the vector mask; and
determining a second bounding box corresponding to a hidden area of the layer based on the layer inclusivity factor of the layer and the mask inclusivity attributes of the raster mask or the vector mask.

6. The computer-implemented method of claim 5, wherein generating the one or more boundary highlights comprises:
generating, for display with the layer within the graphical user interface, a first boundary highlight representing the first bounding box with a first size and a first color value corresponding to the visible area of the layer; and
generating, for display with the layer within the graphical user interface, a second boundary highlight representing the second bounding box with a second size and a second color value corresponding to the hidden area of the layer.

7. The computer-implemented method of claim 1, wherein determining the one or more bounding boxes comprises:
determining an exclusive boundary and an inclusive boundary of the raster mask;
thresholding pixel values in the raster mask to convert the raster mask to a binary mask;
determining, from the binary mask, one or more bounding regions based on the exclusive boundary and the inclusive boundary; and
modifying a bounding region of the one or more bounding regions by adjusting one or more edges of the bounding region to cover one or more gradient values from the raster mask according to a gradient threshold value.

8. The computer-implemented method of claim 1, wherein determining the one or more bounding boxes comprises:
determining an initial boundary of the vector mask utilizing one or more path transform operations on one or more path segments of the vector mask; and
determining the one or more bounding boxes utilizing all path segment boundaries in the vector mask in response to mask inclusivity attributes of the vector mask indicating that the vector mask is exclusive.

9. A system comprising:
one or more memory devices; and
one or more processors coupled to the one or more memory devices that cause the system to perform operations comprising:
determining, by at least one processor, mask inclusivity attributes and mask boundaries for a raster mask or a vector mask for a layer of a digital image;
determining, by the at least one processor, a layer inclusivity factor of the layer based on the mask inclusivity attributes of the raster mask or the vector mask;
determining, by the at least one processor, one or more bounding boxes corresponding to one or more hidden areas of the layer or one or more visible areas of the layer according to the mask boundaries of the raster mask or the vector mask, the layer inclusivity factor of the layer, and layer boundaries of the layer; and
generating, by the at least one processor and for display with the layer within a graphical user interface, one or more boundary highlights representing the one or more bounding boxes corresponding to the one or more hidden areas of the layer or the one or more visible areas of the layer.

10. The system of claim 9, wherein determining the mask inclusivity attributes and the mask boundaries for the raster mask or the vector mask comprises:
determining first mask inclusivity attributes and first mask boundaries for the raster mask corresponding to the layer, the first mask inclusivity attributes indicating that the raster mask is inclusive or exclusive; and
determining second mask inclusivity attributes and second mask boundaries for the vector mask corresponding to the layer, the second mask inclusivity attributes indicating that the vector mask is inclusive or exclusive.

11. The system of claim 10, wherein determining the layer inclusivity factor comprises determining the layer inclusivity factor of the layer as exclusive or inclusive based on a combination of the first mask inclusivity attributes of the raster mask and the second mask inclusivity attributes of the vector mask.

12. The system of claim 9, wherein determining the one or more bounding boxes comprises determining the one or more bounding boxes further based on the mask inclusivity attributes of the raster mask or the vector mask in connection with the mask boundaries of the raster mask or the vector mask.

13. The system of claim 9, wherein determining the one or more bounding boxes comprises:
determining a first bounding box corresponding to a visible area of the layer based on the mask boundaries for the raster mask or the vector mask, the layer inclusivity factor of the layer, and the layer boundaries of the layer; and
determining a second bounding box corresponding to a hidden area of the layer based on the mask boundaries for the raster mask or the vector mask, the layer inclusivity factor of the layer, and the layer boundaries of the layer.

14. The system of claim 13, wherein generating the one or more boundary highlights comprises:
generating a first boundary highlight corresponding to the first bounding box and having a first set of display attributes in response to the first bounding box corresponding to the visible area of the layer; and
determining a second boundary highlight corresponding to the second bounding box and having a second set of display attributes in response to the second bounding box corresponding to the hidden area of the layer.

15. The system of claim 14, wherein generating the one or more boundary highlights comprises:
determining the first set of display attributes comprises determining a first color value indicating that the first boundary highlight corresponds to the visible area; and
determining the second set of display attributes comprises determining a second color value indicating that the first boundary highlight corresponds to the hidden area.

16. The system of claim 9, wherein determining the one or more bounding boxes comprises determining, for the raster mask and the vector mask, a single bounding box corresponding to the one or more hidden areas of the layer or the one or more visible areas of the layer based on the mask inclusivity attributes and in response to determining whether the raster mask and the vector mask overlap according to the mask boundaries.

17. A non-transitory computer readable medium storing instructions thereon that, when executed by at least one processor, cause the at least one processor to perform operations comprising:
determining one or more bounding boxes corresponding to one or more hidden areas or one or more visible areas of a layer of a digital image according to a raster mask or a vector mask corresponding to the layer;
determining display attributes for the one or more bounding boxes in response to determining that the one or more bounding boxes correspond to the one or more hidden areas or the one or more visible areas; and
generating, for display with the layer within a graphical user interface, one or more boundary highlights representing the one or more bounding boxes with the display attributes.

18. The non-transitory computer readable medium of claim 17, wherein determining the one or more bounding boxes comprises:
determining mask inclusivity attributes and mask boundaries of the raster mask or the vector mask; and
determining a bounding box corresponding to a visible area of the layer of the digital image based on the mask inclusivity attributes and the mask boundaries of the raster mask.

19. The non-transitory computer readable medium of claim 17, wherein determining the one or more bounding boxes comprises:
determining mask inclusivity attributes and mask boundaries of the raster mask or the vector mask; and
determining a bounding box corresponding to a hidden area of the layer of the digital image based on the mask inclusivity attributes and the mask boundaries of the raster mask.

20. The non-transitory computer readable medium of claim 17, wherein determining the one or more bounding boxes comprises:
determining a set of display attributes for a bounding box of the one or more bounding boxes in response to determining whether the bounding box corresponds to a hidden area or a visible area of the layer; and
generating, for display on the digital image with the layer within the graphical user interface, a boundary highlight representing the bounding box with the set of display attributes.
